(19) United States
(12) Patent Application Publication
(10) Pub. No.: US 2024/0356815 A1
(43) Pub. Date: Oct. 24, 2024

(54) Machine Learning (ML) Model Retraining in 5G Core Network

(71) Applicant: Telefonaktiebolaget LM Ericsson (publ), Stockholm (SE)

(72) Inventors: Miguel Angel Monjas Llorente, Madrid (ES); Miguel Angel Garcia Martin, Madrid (ES); Piotr Kessler, Österskär (SE)

(21) Appl. No.: 18/682,492

(22) PCT Filed: Sep. 22, 2022
(86) PCT No.: PCT/IB2022/058983

§ 371 Date: Feb. 9, 2024

(30) Foreign Application Priority Data
Oct. 8, 2021 (EP) 21382905.4

(51) Int. Cl. H04L 41/16; H04W 24/02

(52) U.S. Cl. CPC H04L 41/16; H04W 24/02

(57) ABSTRACT

Embodiments include methods for a drift detection logical function (DDLF) of a network data analytics function (NWDAF) of a communication network. Such methods include receiving, from a model training logical function (MTLF) of the NWDAF, a subscription request for drift monitoring notifications associated with a machine learning (ML) model used by an analytics logical function, AnLF, of the NWDAF. Such methods include monitoring for drift associated with the ML model, based on metadata associated with the ML model. Such methods include, based on the monitoring meeting one or more criteria included in the metadata, sending one or more drift monitoring notifications to the MTLF in accordance with the subscription. Other embodiments include complementary methods for MTLF and AnLF, as well as network nodes or functions configured to perform such methods.

### TECHNICAL FIELD

The present application relates generally to the field of communication networks, and more specifically to techniques for generating analytics in a communication network based on machine learning (ML) models, including retraining of such models used in 5G core (5GC) networks.

### INTRODUCTION

Currently the fifth generation (“5G”) of cellular systems, also referred to as New Radio (NR), is being standardized within the Third-Generation Partnership Project (3GPP). NR is developed for maximum flexibility to support multiple and substantially different use cases. These include enhanced mobile broadband (eMBB), machine type communications (MTC), ultra-reliable low latency communications (URLLC), side-link device-to-device (D2D), and several other use cases.

At a high level, the 5G System (5GS) consists of an Access Network (AN) and a Core Network (CN). The AN provides UEs connectivity to the CN, e.g., via base stations such as gNBs or ng-eNBs described below. The CN includes a variety of Network Functions (NF) that provide a wide range of different functionalities such as session management, connection management, charging, authentication, etc.

FIG. 1 illustrates a high-level view of an exemplary 5G network architecture, consisting of a Next Generation Radio Access Network (NG-RAN) 199 and a 5G Core (5GC) 198. NG-RAN 199 can include one or more gNodeB's (gNBs) connected to the 5GC via one or more NG interfaces, such as gNBs 100, 150 connected via interfaces 102, 152, respectively. More specifically, gNBs 100, 150 can be connected to one or more Access and Mobility Management Functions (AMFs) in the 5GC 198 via respective NG-C interfaces. Similarly, gNBs 100, 150 can be connected to one or more User Plane Functions (UPFs) in 5GC 198 via respective NG-U interfaces. Various other network functions (NFs) can be included in the 5GC 198, as described in more detail below.

In addition, the gNBs can be connected to each other via one or more Xn interfaces, such as Xn interface 140 between gNBs 100 and 150. The radio technology for the NG-RAN is often referred to as “New Radio” (NR). With respect the NR interface to UEs, each of the gNBs can support frequency division duplexing (FDD), time division duplexing (TDD), or a combination thereof. Each of the gNBs can serve a geographic coverage area including one more cells and, in some cases, can also use various directional beams to provide coverage in the respective cells.

NG-RAN 199 is layered into a Radio Network Layer (RNL) and a Transport Network Layer (TNL). The NG-RAN architecture, i.e., the NG-RAN logical nodes and interfaces between them, is defined as part of the RNL. For each NG-RAN interface (NG, Xn, F1) the related TNL protocol and the functionality are specified. The TNL provides services for user plane transport and signaling transport.

The NG RAN logical nodes shown in FIG. 1 include a Central Unit (CU or gNB-CU) and one or more Distributed Units (DU or gNB-DU). For example, gNB 100 includes gNB-CU 110 and gNB-DUs 120 and 130. CUs (e.g., gNB-CU 110) are logical nodes that host higher-layer protocols and perform various gNB functions such controlling the operation of DUs. A DU (e.g., gNB-DUs 120, 130) is a decentralized logical node that hosts lower layer protocols and can include, depending on the functional split option, various subsets of the gNB functions.

A gNB-CU connects to one or more gNB-DUs over respective F1 logical interfaces, such as interfaces 122 and 132 shown in FIG. 1. However, a gNB-DU can be connected to only a single gNB-CU. The gNB-CU and connected gNB-DU(s) are only visible to other gNBs and the 5GC as a gNB. In other words, the F1 interface is not visible beyond gNB-CU.

Another change in 5G networks (e.g., in 5GC) is that traditional peer-to-peer interfaces and protocols found in earlier-generation networks are modified and/or replaced by a Service Based Architecture (SBA) in which Network Functions (NFs) provide one or more services to one or more service consumers. This can be done, for example, by Hyper Text Transfer Protocol/Representational State Transfer (HTTP/REST) application programming interfaces (APIs). In general, the various services are self-contained functionalities that can be changed and modified in an isolated manner without affecting other services.

Furthermore, the services are composed of various “service operations”, which are more granular divisions of the overall service functionality. The interactions between service consumers and producers can be of the type “request/response” or “subscribe/notify”. In the 5G SBA, network repository functions (NRF) allow every network function to discover the services offered by other network functions, and Data Storage Functions (DSF) allow every network function to store its context. This 5G SBA model is based on principles including modularity, reusability and self-containment of NFs, which can enable network deployments to take advantage of the latest virtualization and software technologies.

A 5GC NF that is of particular interest in the present disclosure is the Network Data Analytics Function (NWDAF). This NF provides network analytics information (e.g., statistical information of past events and/or predictive information) to other NFs on a network slice instance level. The NWDAF can collect data from any 5GC NF. Note that a “network slice” is a logical partition of a 5G network that provides specific network capabilities and characteristics, e.g., in support of a particular service. A network slice instance is a set of NF instances and the required network resources (e.g., compute, storage, communication) that provide the capabilities and characteristics of the network slice.

Machine learning (ML) is a type of artificial intelligence (AI) that focuses on the use of data and algorithms to imitate the way that humans learn, gradually improving accuracy as more data becomes available. ML algorithms build models based on sample (or “training”) data, with the models being used subsequently to make predictions or decisions. ML algorithms can be used in a wide variety of applications (e.g., medicine, email filtering, speech recognition, etc.) in which it is difficult or unfeasible to develop conventional algorithms to perform the needed tasks. A subset of ML is closely related to computational statistics.

3GPP TS 23.288 (v17.2.0) specifies that NWDAF is the main network function for computing analytics reports, and classifies NWDAF into two sub-functions (or logical functions): Analytics Logical Function (AnLF), which performs analytics procedures; and Model Training Logical Function (MTLF), which performs training and retraining of ML models used by the AnLF.

### SUMMARY

It is expected that ML models will degrade over time, such that retraining of a degraded model or replacement by a new model will be needed. 3GPP TS 23.288 (v17.2.0) specifies that an NWDAF MTLF may determine that further training for an existing ML model is needed, but provides no guidelines and/or requirements for this determination.

ML model retraining may also require data collection that can take a substantial amount of time, during which a known degraded ML model is being used for network analytics. If the degradation is severe, the ML model should be simply terminated since the use of a faulty ML model can be harmful for users and/or the network. A mechanism is needed for reducing the gap between the time when an ML model is determined to be not useful and the time when a retrained ML model is available.

Embodiments of the present disclosure address these and other problems, issues, and/or difficulties, thereby facilitating the otherwise-advantageous deployment of ML models for network analytics.

Some embodiments of the present disclosure include methods (e.g., procedures) for a drift detection logical function (DDLF) of a NWDAF of a communication network (e.g., 5GC).

These exemplary methods can include receiving, from an MTLF of the NWDAF, a subscription request for drift monitoring notifications associated with an ML model used by an AnLF of the NWDAF. These exemplary methods can also include monitoring for drift associated with the ML model, based on metadata associated with the ML model. These exemplary methods can also include, based on the monitoring meeting one or more criteria included in the metadata, sending one or more drift monitoring notification to the MTLF in accordance with the subscription.

In some embodiments, the monitoring is performed (e.g., in block 840) on a plurality of monitoring objects. Each monitoring object is associated with one of the following types of data:
raw data acquired by the AnLF for input to the ML model;
feature vectors computed by the AnLF based on the raw data; and
predictions based on the ML model.

In some variants, each monitoring object associated with predictions based on the ML model is also associated with actual values corresponding to the predictions, when such actual values are available.

In some of these embodiments, the metadata associated with the ML model includes a drift detection configuration, which includes one or more of the following for each particular one of the monitoring objects:
access information for data to be used for the particular monitoring object;
specific attributes and/or subsets of data to be used for the particular monitoring object; and
size, duration, and/or sampling ratio of data to be used for the particular monitoring object.

In some variants, the drift detection configuration also includes:
for each particular monitoring object associated with raw data or feature vectors, identification of supported data drift tests; and
for each particular monitoring object associated with predictions based on the ML model, identification of relevant performance metrics and one or more thresholds for each relevant performance metric.

In some embodiments, monitoring for drift is performed periodically according to a monitoring period included in the metadata. Additionally, monitoring for drift can include, at each monitoring period, evaluating a metric for the type of data associated with each monitoring object.

In some of these embodiments, the one or more drift monitoring notifications sent to the MTLF include periodic drift monitoring notifications corresponding to the periodic evaluations. In such embodiments, each (periodic) drift monitoring notification includes one or more the following:
an identifier of the ML model or of analytics associated with the drift monitoring,
a timestamp,
observed drift levels associated with each monitoring object,
an identifier of a data drift test or performance metric used for each monitoring object, and
a value of the metric for the type of data associated with each monitoring object.

In other of these embodiments, monitoring for drift further comprises the following operations at each monitoring period:
determining respective first relations between the respective metrics for the monitoring objects and respective thresholds associated with the monitoring objects; and
determining whether drift has occurred based on a second relation among the respective first relations; and
when it is determined that drift has occurred, determining whether the drift is severe based on a termination threshold.

The thresholds, the first relations, the second relation, and the termination threshold can be part of the drift monitoring configuration.

In such embodiments, the one or more criteria in the metadata (i.e., that monitoring must meet to trigger a drift monitoring notification) include that drift has occurred. In such case, the drift monitoring notification includes one or more of the following:
an indication of whether the drift is severe;
an identifier of the ML model or of analytics associated with the drift monitoring;
a timestamp;
a periodicity of the drift monitoring; and
a value of the metric for the type of data associated with each monitoring object.

In some embodiments, monitoring for drift can include the following operations:
initiating respective drift monitors for the monitoring objects;
receiving respective drift notifications from the drift monitors, and
subsequently shutting down the respective drift monitors.

In such embodiments, the one or more drift monitoring notifications sent to the MTLF are based on the respective drift notifications from the drift monitors.

In some embodiments, the subscription request includes one or more of the following:
the metadata associated with the ML model;
one or more analytics identifiers associated with the drift monitoring;
one or more ML model identifiers associated with the drift monitoring;
an address to send drift monitoring notifications;
a timestamp of the subscription request; and
a duration of validity for the subscription request.

In some of these embodiments (e.g., where the subscription request does not include the metadata), the exemplary method can also include, in response to receiving the subscription request, sending to the MTLF a request for ML model information and receiving from the MTLF a response that includes the metadata associated with the ML model.

Other embodiments include exemplary methods (e.g., procedures) for an MTLF of an NWDAF of a communication network (e.g., 5GC).

These exemplary methods can include sending, to a DDLF of the NWDAF, a subscription request for drift monitoring notifications associated with an ML model used by an AnLF of the NWDAF. These exemplary methods can also include subsequently receiving one or more drift monitoring notifications from the DDLF in accordance with the subscription. These exemplary methods can also include determining one or more of the following based on the drift monitoring notifications: whether to retrain the ML model, whether to notify the AnLF to terminate use of the ML model, and whether to train a different ML model.

In various embodiments, the subscription request can include any of the information summarized above in relation to DDLF embodiments.

In some embodiments (e.g., where the subscription request does not include the metadata), these exemplary methods can also include, in response to sending the subscription request, receiving from the DDLF a request for ML model information and sending, to the DDLF, a response that includes the metadata associated with the ML model.

In some embodiments, each drift monitoring notification is based on a plurality of monitoring objects, with each monitoring object being associated with one of the following types of data:
raw data acquired by the AnLF for input to the ML model;
feature vectors computed by the AnLF based on the raw data; and
predictions based on the ML model.

In some variants, each monitoring object associated with predictions based on the ML model is also associated with actual values corresponding to the predictions, when such actual values are available.

In some of these embodiments, the metadata associated with the ML model includes a drift detection configuration, which can include any of the information summarized above in relation to DDLF embodiments.

In some embodiments, monitoring for drift is performed periodically by the DDLF according to a monitoring period included in the metadata. The one or more drift monitoring notifications received from the DDLF include periodic drift monitoring notifications corresponding to the monitoring period. In some of these embodiments, each (periodic) drift monitoring notification includes one or more the following:
an identifier of the ML model or of analytics associated with the drift monitoring,
a timestamp,
observed drift levels associated with each monitoring object,
an identifier of a data drift test or performance metric used for each monitoring object, and
a value of the metric for the type of data associated with each monitoring object.

In some of these embodiments, these exemplary methods can also include the following operations at each monitoring period:
determining respective first relations between the respective metrics for the monitoring objects and respective thresholds associated with the monitoring objects;
determining whether drift has occurred based on a second relation among the respective first relations; and
when it is determined that drift has occurred, determining whether the drift is severe based on a termination threshold.

The thresholds, the first relations, the second relation, and the termination threshold can be part of the drift monitoring configuration.

In other of these embodiments, each drift monitoring notification is received based on a determination by the DDLF that drift has occurred. In such embodiments, each drift monitoring notification includes one or more of the following:
an indication of whether the drift is severe;
an identifier of the ML model or of analytics associated with the drift monitoring;
a timestamp;
a periodicity of the drift monitoring; and
a value of a metric for the type of data associated with each monitoring object.

In some embodiments, these exemplary methods can also include, based on an indication by the DDLF or a determination by the MTLF that the drift of the ML model has occurred, retraining the ML model and notify the AnLF of availability of a retrained ML model. In some embodiments, these exemplary methods can also include notifying the AnLF to terminate use of the ML model based on an indication by the DDLF or a determination by the MTLF that the drift of the ML model is severe.

In some of these embodiments, these exemplary methods can also include receiving, from the AnLF, a subscription request for notifications associated with the ML model. The subscription request to the DDLF for drift monitoring notifications is based on the subscription request received from the AnLF and notifying the AnLF is based on the subscription request.

Other embodiments include methods (e.g., procedures) for an AnLF of an NWDAF of a communication network (e.g., 5GC).

These exemplary methods can include applying an ML model to raw data acquired by the AnLF to obtain predictions for analytics associated with the communication network. These exemplary methods can also include sending, to an MTLF of the NWDAF, a subscription request for notifications associated with the ML model. These exemplary methods can also include receiving one or more of the following from the MTLF based on the subscription request: a notification of availability of a retrained ML model, and a notification to terminate use of the ML model.

In some embodiments, the subscription request sent to the MTLF includes one or more of the following:
metadata associated with the ML model;
one or more analytics identifiers;
one or more ML model identifiers;
an address to send notifications;
a timestamp of the subscription request; and
a duration of validity for the subscription request.

In some embodiments, these exemplary methods can also include storing one or more of the following information in a data repository accessible by the MTLF and by a DDLF of the NWDAF:
the raw data;
feature vectors for the ML model computed by the AnLF based on the raw data; and
predictions based on the ML model.

In some variants, the information stored in the data repository also includes actual values corresponding to the predictions based on the ML model, when such actual values are available.

In some embodiments, these exemplary methods can also include, based on receiving a notification of availability of a retrained ML model, obtaining the retrained ML model from the MTLF and applying the retrained ML model instead of the ML model. In some embodiments, these exemplary methods can also include terminating use of the ML model based on receiving a notification to terminate use of the ML model.

Other embodiments include DDLFs, MTLFs, and AnLFs (or network nodes hosting the same) that are configured to perform the operations corresponding to any of the exemplary methods described herein. Other embodiments also include non-transitory, computer-readable media storing computer-executable instructions that, when executed by processing circuitry associated with such DDLFs, MTLFs, and AnLFs, configure the same to perform operations corresponding to any of the exemplary methods described herein.

These and other disclosed embodiments can facilitate detecting drift in an ML model used for NWDAF analytics and providing timely indication of the drift to a MTLF, which can retrain the ML model before the inaccuracy due to drift reaches an unacceptable level, e.g., in advance of a periodic and/or predefined model retraining event. Alternately, the MTLF can trigger termination of the ML model when the detected drift and/or inaccuracy becomes too severe, reports. Additionally, detection and provisioning of ML model drift is simplified since it is performed by a specific logical function, e.g., DDLF.

These and other objects, features, and advantages of the present disclosure will become apparent upon reading the following Detailed Description in view of the Drawings briefly described below.

### BRIEF DESCRIPTION OF THE DRAWINGS

FIGS. 1-2 illustrate various aspects of an exemplary 5G network architecture.

FIG. 3 shows an exemplary procedure for an NWDAF service consumer to subscribe for notifications about ML model availability from an NWDAF (MTLF).

FIG. 4 shows an exemplary procedure for an NWDAF service consumer to retrieve information about ML model(s) from an NWDAF (MTLF).

FIG. 5 shows a block diagram of an NWDAF, according to various embodiments of the present disclosure.

FIG. 6 shows a signal flow diagram of a procedure involving drift monitoring of an ML model, according to various embodiments of the present disclosure.

FIG. 7 shows an exemplary procedure for managing a drift monitor, according to various embodiments of the present disclosure.

FIG. 8 shows an exemplary method (e.g., procedure) for a DDLF of a NWDAF of a communication network, according to various embodiments of the present disclosure.

FIG. 9 shows an exemplary method (e.g., procedure) for an MTLF of a NWDAF of a communication network, according to various embodiments of the present disclosure.

FIG. 10 shows an exemplary method (e.g., procedure) for a AnLF of a NWDAF of a communication network, according to various embodiments of the present disclosure.

FIG. 11 shows a communication system according to various embodiments of the present disclosure.

FIG. 12 shows a UE according to various embodiments of the present disclosure.

FIG. 13 shows a network node according to various embodiments of the present disclosure.

FIG. 14 shows host computing system according to various embodiments of the present disclosure.

FIG. 15 is a block diagram of a virtualization environment in which functions implemented by some embodiments of the present disclosure may be virtualized.

FIG. 16 illustrates communication between a host computing system, a network node, and a UE via multiple connections, according to various embodiments of the present disclosure.

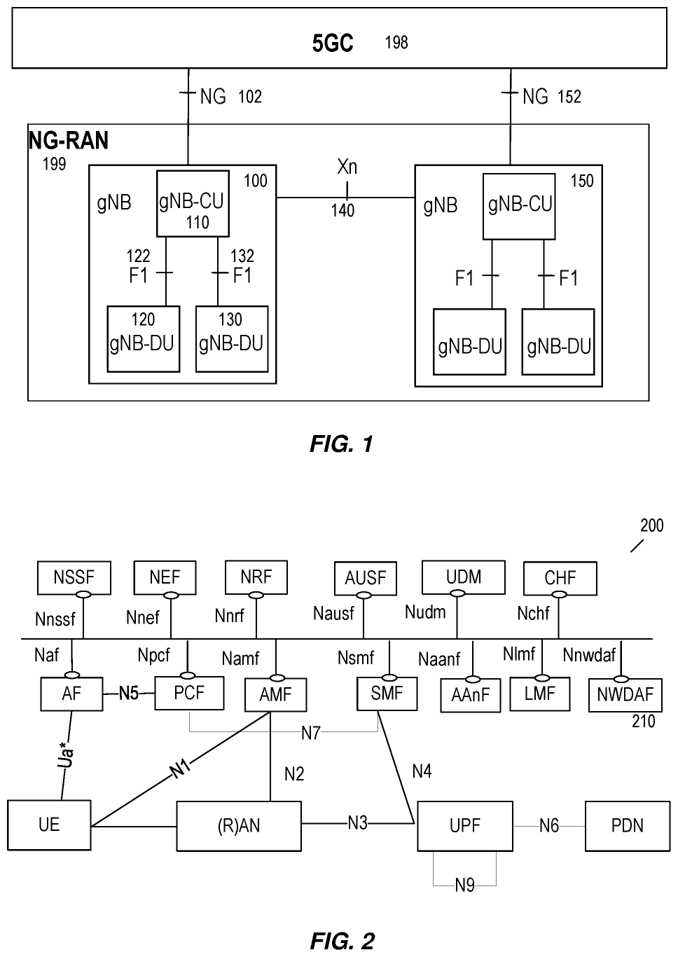

### DETAILED DESCRIPTION

Embodiments briefly summarized above will now be described more fully with reference to the accompanying drawings. These descriptions are provided by way of example to explain the subject matter to those skilled in the art and should not be construed as limiting the scope of the subject matter to only the embodiments described herein. More specifically, examples are provided below that illustrate the operation of various embodiments according to the advantages discussed above.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods and/or procedures disclosed herein do not have to be performed in the exact order disclosed, unless a step is explicitly described as following or preceding another step and/or where it is implicit that a step must follow or precede another step. Any feature of any of the embodiments disclosed herein can be applied to any other embodiment, wherever appropriate. Likewise, any advantage of any of the embodiments can apply to any other embodiments, and vice versa. Other objects, features and advantages of the disclosed embodiments will be apparent from the following description.

Furthermore, the following terms are used throughout the description given below:
Radio Access Node: As used herein, a “radio access node” (or equivalently “radio network node,” “radio access network node,” or “RAN node”) can be any node in a radio access network (RAN) of a cellular communications network that operates to wirelessly transmit and/or receive signals. Some examples of a radio access node include, but are not limited to, a base station (e.g., a New Radio (NR) base station (gNB) in a 3GPP Fifth Generation (5G) NR network or an enhanced or evolved Node B (eNB) in a 3GPP LTE network), base station distributed components (e.g., CU and DU), a high-power or macro base station, a low-power base station (e.g., micro, pico, femto, or home base station, or the like), an integrated access backhaul (IAB) node (or component thereof such as MT or DU), a transmission point, a remote radio unit (RRU or RRH), and a relay node.
Core Network Node: As used herein, a “core network node” is any type of node in a core network. Some examples of a core network node include, e.g., a Mobility Management Entity (MME), a serving gateway (SGW), a Packet Data Network Gateway (P-GW), etc. A core network node can also be a node that implements a particular core network function (NF), such as an access and mobility management function (AMF), a session management function (SMF), a user plane function (UPF), a Service Capability Exposure Function (SCEF), or the like.
Wireless Device: As used herein, a “wireless device” (or “WD” for short) is any type of device that has access to (i.e., is served by) a cellular communications network by communicate wirelessly with network nodes and/or other wireless devices.

Communicating wirelessly can involve transmitting and/or receiving wireless signals using electromagnetic waves, radio waves, infrared waves, and/or other types of signals suitable for conveying information through air. Unless otherwise noted, the term “wireless device” is used interchangeably herein with “user equipment” (or “UE” for short). Some examples of a wireless device include, but are not limited to, smart phones, mobile phones, cell phones, voice over IP (VoIP) phones, wireless local loop phones, desktop computers, personal digital assistants (PDAs), wireless cameras, gaming consoles or devices, music storage devices, playback appliances, wearable devices, wireless endpoints, mobile stations, tablets, laptops, laptop-embedded equipment (LEE), laptop-mounted equipment (LME), smart devices, wireless customer-premise equipment (CPE), mobile-type communication (MTC) devices, Internet-of-Things (IoT) devices, vehicle-mounted wireless terminal devices, mobile terminals (MTs), etc.
Radio Node: As used herein, a “radio node” can be either a “radio access node” (or equivalent term) or a “wireless device.”
Network Node: As used herein, a “network node” is any node that is either part of the radio access network (e.g., a radio access node or equivalent term) or of the core network (e.g., a core network node discussed above) of a cellular communications network. Functionally, a network node is equipment capable, configured, arranged, and/or operable to communicate directly or indirectly with a wireless device and/or with other network nodes or equipment in the cellular communications network, to enable and/or provide wireless access to the wireless device, and/or to perform other functions (e.g., administration) in the cellular communications network.
Node: As used herein, the term “node” (without any prefix) can be any type of node that is capable of operating in or with a wireless network (including a RAN and/or a core network), including a radio access node (or equivalent term), core network node, or wireless device.
Service: As used herein, the term “service” refers generally to a set of data, associated with one or more applications, that is to be transferred via a network with certain specific delivery requirements that need to be fulfilled in order to make the applications successful.
Component: As used herein, the term “component” refers generally to any component needed for the delivery of a service. Examples of component are RANs (e.g., E-UTRAN, NG-RAN, or portions thereof such as eNBs, gNBs, base stations (BS), etc.), CNs (e.g., EPC, 5GC, or portions thereof, including all type of links between RAN and CN entities), and cloud infrastructure with related resources such as computation, storage. In general, each component can have a “manager”, which is an entity that can collect historical information about utilization of resources as well as provide information about the current and the predicted future availability of resources associated with that component (e.g., a RAN manager).

Note that the description given herein focuses on a 3GPP cellular communications system and, as such, 3GPP terminology or terminology similar to 3GPP terminology is generally used. However, the concepts disclosed herein are not limited to a 3GPP system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from the concepts, principles, and/or embodiments described herein.

In addition, functions and/or operations described herein as being performed by a wireless device or a network node may be distributed over a plurality of wireless devices and/or network nodes. Furthermore, although the term “cell” is used herein, it should be understood that (particularly with respect to 5G NR) beams may be used instead of cells and, as such, concepts described herein apply equally to both cells and beams.

FIG. 2 shows an exemplary non-roaming reference architecture for a 5GC (200), with service-based interfaces and various 3GPP-defined NFs within the Control Plane (CP). These include the following:
Application Function (AF, with Naf interface) interacts with the 5GC to provision information to the network operator and to subscribe to certain events happening in operator's network. An AF offers applications for which service is delivered in a different layer (i.e., transport layer) than the one in which the service has been requested (i.e., signaling layer), the control of flow resources according to what has been negotiated with the network. An AF communicates dynamic session information to PCF (via N5 interface), including description of media to be delivered by transport layer.
Policy Control Function (PCF, with Npcf interface) supports unified policy framework to govern the network behavior, via providing PCC rules (e.g., on the treatment of each service data flow that is under PCC control) to the SMF via the N7 reference point. PCF provides policy control decisions and flow based charging control, including service data flow detection, gating, QoS, and flow-based charging (except credit management) towards the SMF. The PCF receives session and media related information from the AF and informs the AF of traffic (or user) plane events.
User Plane Function (UPF)— supports handling of user plane traffic based on the rules received from SMF, including packet inspection and different enforcement actions (e.g., event detection and reporting). UPFs communicate with the RAN (e.g., NG-RNA) via the N3 reference point, with SMFs (discussed below) via the N4 reference point, and with an external packet data network (PDN) via the N6 reference point. The N9 reference point is for communication between two UPFs.
Session Management Function (SMF, with Nsmf interface) interacts with the decoupled traffic (or user) plane, including creating, updating, and removing Protocol Data Unit (PDU) sessions and managing session context with the User Plane Function (UPF), e.g., for event reporting. For example, SMF performs data flow detection (based on filter definitions included in PCC rules), online and offline charging interactions, and policy enforcement.
Charging Function (CHF, with Nchf interface) is responsible for converged online charging and offline charging functionalities. It provides quota management (for online charging), re-authorization triggers, rating conditions, etc. and is notified about usage reports from the SMF. Quota management involves granting a specific number of units (e.g., bytes, seconds) for a service. CHF also interacts with billing systems.
Access and Mobility Management Function (AMF, with Namf interface) terminates the RAN CP interface and handles all mobility and connection management of UEs (similar to MME in EPC). AMFs communicate with UEs via the N1 reference point and with the RAN (e.g., NG-RAN) via the N2 reference point.
Network Exposure Function (NEF) with Nnef interface—acts as the entry point into operator's network, by securely exposing to AFs the network capabilities and events provided by 3GPP NFs and by providing ways for the AF to securely provide information to 3GPP network. For example, NEF provides a service that allows an AF to provision specific subscription data (e.g., expected UE behavior) for various UEs.
Network Repository Function (NRF) with Nnrf interface—provides service registration and discovery, enabling NFs to identify appropriate services available from other NFs.
Network Slice Selection Function (NSSF) with Nnssf interface—a “network slice” is a logical partition of a 5G network that provides specific network capabilities and characteristics, e.g., in support of a particular service. A network slice instance is a set of NF instances and the required network resources (e.g., compute, storage, communication) that provide the capabilities and characteristics of the network slice. The NSSF enables other NFs (e.g., AMF) to identify a network slice instance that is appropriate for a UE's desired service.
Authentication Server Function (AUSF) with Nausf interface—based in a user's home network (HPLMN), it performs user authentication and computes security key materials for various purposes.
Network Data Analytics Function (NWDAF, 210) with Nnwdaf interface, described in more detail above and below.
Location Management Function (LMF) with Nlmf interface—supports various functions related to determination of UE locations, including location determination for a UE and obtaining any of the following: DL location measurements or a location estimate from the UE; UL location measurements from the NG RAN; and non-UE associated assistance data from the NG RAN.

The Unified Data Management (UDM) function supports generation of 3GPP authentication credentials, user identification handling, access authorization based on subscription data, and other subscriber-related functions. To provide this functionality, the UDM uses subscription data (including authentication data) stored in the 5GC unified data repository (UDR). In addition to the UDM, the UDR supports storage and retrieval of policy data by the PCF, as well as storage and retrieval of application data by NEF.

The NRF allows every NF to discover the services offered by other NFs, and Data Storage Functions (DSF) allow every NF to store its context. In addition, the NEF provides exposure of capabilities and events of the 5GC to AFs within and outside of the 5GC. For example, NEF provides a service that allows an AF to provision specific subscription data (e.g., expected UE behavior) for various UEs.

Communication links between the UE and a 5G network (AN and CN) can be grouped in two different strata. The UE communicates with the CN over the Non-Access Stratum (NAS), and with the AN over the Access Stratum (AS). All the NAS communication takes place between the UE and the AMF via the NAS protocol (N1 interface in FIG. 2). Security for the communications over this these strata is provided by the NAS protocol (for NAS) and the PDCP protocol (for AS).

3GPP Rel-17 enhances the SBA by adding a Data Management Framework that includes a Data Collection Coordination Function (DCCF) and a Messaging Framework Adaptor Function (MFAF), which are defined in detail in 3GPP TR 23.700-91 (v17.0.0). The Data Management Framework is backward compatible with a Rel-16 NWDAF function, described above. For Rel-17, the baseline for services offered by the DCCF (e.g., to an NWDAF) are the Rel-16 NF Services used to obtain data. For example, the baseline for the DCCF service used by an NWDAF consumer to obtain UE mobility data is Namf_EventExposure.

3GPP TS 23.288 (v17.2.0) specifies that NWDAF is the main network function for computing analytics reports. The 5G system architecture allows any NF to obtain analytics from an NWDAF using a DCCF function and associated Ndccf services. The NWDAF can also store and retrieve analytics information from an Analytics Data Repository Function (ADRF).

3GPP TS 23.288 also classifies NWDAF into two sub-functions (or logical functions): NWDAF Analytics Logical Function (NWDAF AnLF), which performs analytics procedures; and NWDAF Model Training Logical Function (NWDAF MTLF), which performs training and retraining of ML models used by NWDAF AnLF. In the following, the terms “AnLF”, “NWDAF AnLF”, and “NWDAF (AnLF)” will be used interchangeably. Likewise, the terms “MTLF”, “NWDAF MTLF”, and “NWDAF (MTLF)” will be used interchangeably.

3GPP TS 23.288 (v17.2.0) specifies a subscribe/notify procedure for a consumer NF to retrieve ML model(s) associated with one or more Analytics IDs whenever a new ML model has been trained by the NWDAF MTLF and becomes available. This is referred to as ML Model Provisioning and is implemented by the Nnwdaf_MLModelProvision service.

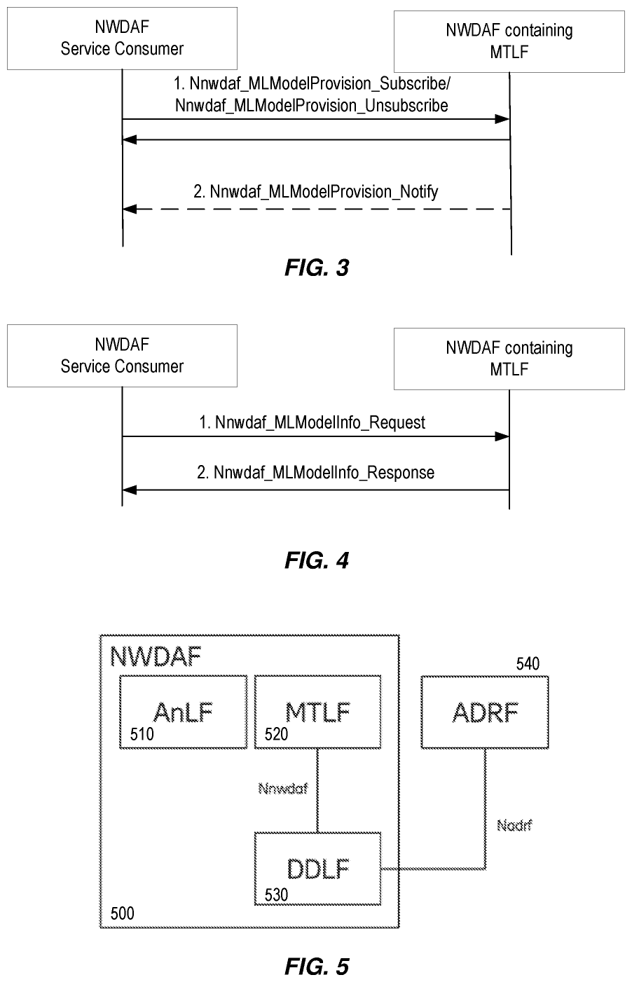

FIG. 3 shows an exemplary procedure for an NWDAF service consumer (e.g., NWDAF (AnLF) to subscribe for notifications about ML model availability from a NWDAF (MTLF). As mentioned above, the procedure is implemented based on Nnwdaf_MLModelProvision_Subscribe and Nnwdaf_MLModelProvision_Notify messages that are part of the Nnwdaf_MLModelProvision service. 3GPP TS 23.288 section 6.2A describes the procedure in more detail.

3GPP TS 23.288 (v17.2.0) also specifies a request/response procedure for consumer NF (e.g., NWDAF AnLF) to retrieve information about ML model(s) associated with one or more Analytics IDs. This procedure is implemented by the Nnwdaf_MLModelInfo service and is illustrated in FIG. 4.

As briefly mentioned above, it is expected that ML models will degrade over time, such that retraining of a degraded model or replacement by a new model will be needed. 3GPP TS 23.288 (v17.2.0) specifies that NWDAF (MTLF) may determine that further training for an existing ML model is needed but provides no guidelines and/or requirements for this determination.

Furthermore, ML model retraining may require data collection that can take a substantial amount of time, during which a known degraded ML model is being used for network analytics. If degradation is severe, the ML model should be simply terminated since use of a faulty ML model can be harmful for users and/or the network. A mechanism is needed for reducing the gap between the time when an ML model is determined to be not useful and the time when an updated ML model is available.

Embodiments of the present disclosure address these and other problems, issues, and/or difficulties by providing a new NWDAF logical function for monitoring whether ML model drift has occurred. This new logical function can be referred to as NWDAF Drift Detector Logical Function, NWDAF(DDLF), DDLF, or by other names that represent a similar function. The NWDAF(DDLF) can inform NWDAF(MTLF) of an observed level of drift of an ML model. NWDAF(MTLF) can use this information for triggering a retraining of the ML model, as needed, in a timely manner. For example, the NWDAF(MTLF) can detect in advance a trend of decreasing reliability of the results produced by the ML model, even though the results are still within a valid range. As such, NWDAF(MTLF) can determine whether ML model retraining is needed before results become invalid. Furthermore, the NWDAF(MTLF) can notify the NWDAF(AnLF) not only when a new ML model release is available (as currently) but also when the ML model must be terminated due to severe degradation.

In addition to the procedures for the provision and use of the drift information, embodiments include drift monitoring procedures that can be used by NWDAF(DDLF). Embodiments also include contents of the ML model metadata that facilitate support for the procedures. For example, such ML model metadata can be supplied through the Nnwdaf_MLModelInfo service.

Embodiments of the present disclosure can provide various benefits and/or advantages. For example, embodiments can facilitate detecting drift of an ML model. Also, an NWDAF(MTLF) can receive information (“drift report”) indicating that an ML model that it is handling is subject to a level of drift that will produce inaccurate results; the NWDAF(MTLF) can analyze successive drift reports to determine a trend. Based on this analysis, the NWDAF(MTLF) can trigger retraining of the ML model before the inaccuracy reaches an unacceptable level, e.g., in advance of a periodic and/or predefined model retraining event. Embodiments also facilitate an NWDAF(MTLF) to trigger termination of an ML model at a NWDAF(AnLF) based on the analysis of the drift reports. For example, this can be done by the Nnwdaf_MLModelProvision_Notify service operation, such as shown in FIG. 3.

Additionally, detection and provisioning of ML model drift is simplified since it is performed by a specific logical function, NWDAF(DDLF), rather than being embedded within multiple logical functions. For example, interworking between the NWDAF(MTLF) and the NWDAF(DDLF) can be through a newly defined service called, e.g., Nnwdaf_MLModelDriftMonitoring.

Embodiments also facilitate specification of ML model drift detection on a model-by-model basis, e.g., through the Nnwdaf_MLModelInfo service.

In some embodiments, the NWDAF(DDLF) can perform drift monitoring on one or more of the following, each of which can be referred to as a “monitoring object”:
Raw data that the NWDAF(AnLF) is acquiring for analytics computation. This raw data may be stored in an ADRF or even in the NWDAF(AnLF) itself, from which the NWDAF(DDLF) can retrieve the data of interest. Alternatively, the NWDAF(DDLF) can subscribe to the data as it is being produced in real time, perhaps through a DCCF/MFAF. In any case, the NWDAF(DDLF) has access to the real raw data produced by the different network functions.
Feature vectors, which are created by NWDAF(AnLF) as part of the data pre-processing and feature engineering stages in the inference pipeline so that they are the actual input of an ML model.
Predictions (e.g., analytics reports), which can be evaluated against any corresponding actual values that are available.

FIG. 5 shows a block diagram of an NWDAF (500) according to various embodiments of the present disclosure. In particular, FIG. 5 shows an NWDAF including an AnLF (510), an MTLF (520), and a DDLF (530). The NWDAF (DDLF) communicates with an ADRF (540) via Nadrf services and with the NWDAF (MTLF) via Nnwdaf services.

If an ADRF or a DCCF are deployed in the network, the NWDAF(DDLF) uses the Nadrf or Ndccf services to request either the collected data from the past or a subscription to real-time data and carries out drift monitoring operations on the monitoring objects. Therefore, it might be necessary to configure 5GC NFs so that data associated to each of the monitoring objects listed above is stored and made available to the NWDAF(DDLF):
Raw data storage can be by the NWDAF(AnLF) or by the NFs themselves.
Feature vectors are stored by the NWDAF(AnLF).
Prediction storage may be handled by the NWDAF(AnLF) or by the NFs that consume analytics reports. Storage of available actual values corresponding to the predictions can be handled by the NWDAF(AnLF) (e.g., if it receives the actual values, such as in some UE mobility scenarios) or by the NFs that consume analytics reports since they usually are able to compare predictions with actual values.

Monitoring of the raw data and feature vector monitoring objects can be used to detect so-called “data drift”, e.g., whether there has been a change in the distribution of input data. In such case, monitoring can include execution of one or more data drift tests to the corresponding data. Monitoring of the predictions monitoring object can be used to measure model performance and to detect so-called “concept drift”. In such case, monitoring can include computation of a model performance metric.

To be able to monitor drift at the ML model level, the NWDAF(MTLF) must be able to map Analytics ID(s) to ML model IDs, so that it can request and receive drift notifications at ML model level from the NWDAF(AnLF).

The NWDAF(DDLF) should be able to access a drift detection configuration specific to each Analytics ID or relevant scope. For example, a single ML model (e.g., with a model ID) can support different Analytics IDs or, conversely, a single Analytics ID can be served by several ML models (e.g., with different model IDs). A drift detection configuration can specify which monitoring objects are supported. For each supported monitoring object, the drift detection configuration can include one or more of the following items:
Generic information about how to access the NF that stores the raw data for verifying drift in the specific monitoring object, e.g., location, credentials, database structure, etc.
Specific information about data in each monitoring object, e.g., data schemas, subset of the data to which drift monitoring tests must be applied. As a more specific example, a raw observation may be made of several attributes, but only some of them are important for the implementation of the ML model. Thus, a data drift test can be limited to these attributed deemed important.
Size or time window of the dataset used to verify drift in the specific monitoring object, as well as any applicable sampling ratio.
For raw data acquisition and feature vectors monitoring objects, identification of supported data drift tests (e.g., Kolmogorov-Smirnov, Kullback-Leibler divergence, etc.) as well as threshold(s) for each supported test.
For predictions monitoring objects, identification of relevant performance metrics (e.g., Mean Squared Error, Root Mean Squared Error, Mean Absolute Error, etc.) as well as threshold(s) for each relevant performance metric.

In some embodiments, some or all of the above-listed items can be part of meta-data associated with each ML model. In such case, NWDAF(DDLF) can retrieve the ML model meta-data using the Nnwdaf_ILModelInfo service. The ML mode metadata can be structured and/or provisioned in any way that is technically feasible, suitable, and/or convenient.

In some embodiments, a new ML Model Drift Monitoring service can be added to the existing collection of Nnwdaf services. The new service (e.g., Nnwdaf_MLModelDriftMonitoring) can include two service operations to allow the NWDAF(MTLF) to subscribe/unsubscribe and to receive corresponding notifications about the results of the drift monitoring operations. Any existing service operations to request ML model meta-data (e.g., Nnwdaf_MLModelInfo service) do not need to be updated, since the outcome of a request is a URL to the location of said meta-data at the NWDAF(MTLF). Even so, embodiments provide a minimal set of ML model meta-data items to support the overall behavior described herein.

In some embodiments, the NWDAF(DDLF) only performs periodic drift monitoring operations and delivers the results to the NWDAF(MTLF), which determines whether there is a level of drift that requires ML model retraining. If so, the NWDAF(MTLF) can decide to retrain the existing ML model (or train a new ML model, as the case may be).

In these embodiments, notifications can be delivered each time a drift monitoring operation is carried out, independently of the result of drift detection. Each notification can include an Analytics ID or ML model ID associated with the drift monitoring, a timestamp, and observed drift levels associated with each monitoring object. In some cases, for each monitoring object, the notification can also include an identifier of a data drift test or accuracy metric used, and a numeric result of the data drift test or the accuracy metric used.

In other embodiments, the NWDAF(DDLF) not only performs periodic drift monitoring operations but also determines whether there is a level of drift that requires ML model retraining. This way, it only notifies NWDAF(MTLF) when there is an actual drift, based on which the NWDAF(MTLF) can decide to retrain the existing ML model. These embodiments reduce network traffic since notifications are only delivered when the NWDAF(DDLF) detects drift. Moreover, the identifier and the numeric result of the data drift test and/or accuracy metric used is optionally included in the notification.

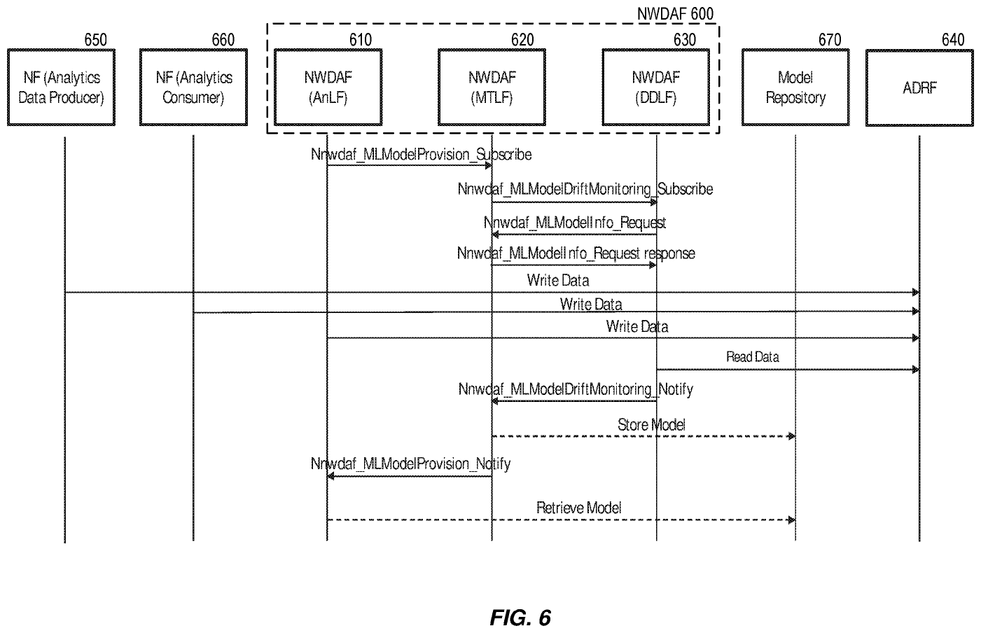

FIG. 6 shows a signal flow diagram according to some embodiments of the present disclosure. For example, the signaling shown in FIG. 6 can be an enhancement to the Nnwdaf_MLModelProvision service signaling shown in FIG. 3, including the involvement of entities such as NWDAF(AnLF) 610, NWDAF(MTLF) 620, NWDAF(DDLF) 630, ADRF 640, analytics data producer NF 650, analytics data consumer NF 660, and ML model repository 670. Note that although an ML model repository is not explicitly described in 3GPP TS 23.288, its presence is implicit: it is where ML models are stored by the NWDAF(MTLF) and subsequently retrieved by the NWDAF(AnLF). The signaling assumes that data is stored in ADRF, although an option where the NWDAF(DDLF) receives the data in real time from the NFs (e.g., via DCCF/MFAF) is also possible but not shown.

As a pre-requisite, the NWDAF(MTLF) is provisioned with relevant ML model meta-data, such as the exemplary metadata shown below:

| model_name: ue_mobility_random_forest | |
|---|---|
| model_version: 10 | |
| drift_detection_configuration: | |
| monitoring_evaluation: | |
| - | and |
| - | raw |
| - | - not |
| | - prediction |
| monitoring_termination_evaluation: | |
| - | prediction |
| monitoring_period: 2w | |
| monitoring_drift_recurrent_events: 2 | |
| monitoring_objects: | |
| - | monitoring_object: raw |
| | monitoring_datasource: raw_datastore |
| | monitoring_attributes: |
| | - gnodeb_1 |
| | - gnodeb_2 |
| | - staytime_1 |
| | start: 1w |
| | end: 0w |
| | sampling_rate: 0.1 |
| | monitoring_metric: ks |
| | monitoring_metric_operator: gt |
| | monitoring_threshold: 90 |
| | monitoring_termination_threshold: 250 |
| - | monitoring_object: predictions |
| | monitoring_datasource: score_datastore |
| | start: 1w |
| | end: 0w |
| | sampling_rate: 1 |
| | monitoring_metric: mae |
| | monitoring_metric_operator: gt |
| | monitoring_threshold: 345 |
| | monitoring_termination_threshold: 1000 |

The information in the above metadata can be defined as follows:
model_name: Name of the ML model the meta-data refers to.
model_version: Identifier of the last valid release of the ML model.
drift_detection_configuration: Configuration associated to each of the monitoring objects and the way to evaluate, where:
   monitoring_evaluation: Includes a logical expression to determine when, from the results of the evaluation of the monitoring points in monitoring_objects, drift is deemed to have happened. For example, a YAML encoding of the logical expression following the LISP way of evaluating logical operators (i.e., in the example above, it should be read as (and, “raw”, (not, “predictions”)), where and not are logical operators while “raw” and “predictions” are names of monitoring points declared in monitoring_objects.
   monitoring_termination_evaluation: Includes a logical expression to determine when, from the results of the evaluation of the monitoring points in monitoring_objects, severe drift is deemed to have happened.
   monitoring_period: How frequently the monitoring operation must be carried out.
   monitoring_drift_recurrent_events: If present, it states the amount of successive drift events to consider drift has happened.
   monitoring_objects: An array where each item contains the configuration associated to a monitoring object:
      monitoring_object: Monitoring object name.
      monitoring_datasource: Reference to the data source that supports this monitoring object.
      monitoring_attributes: List of data attributes that must be monitored. If absent, all attributes in the data source are tested.
      start/end: If the dataset is time-based, how to determine the dataset to use (if not, size, the number of observations, can be used).
      sampling_rate: Ratio of data to use to perform a test (value between 1.0 and 0.0).
      monitoring_metric: Monitoring metric to use.
      monitoring_metric_operator: Comparison operators used to determine if the metric value means a drift. Examples of values can be eq (equality), gt (greater than), it (less than) . . .
      monitoring_threshold: Monitoring metric threshold. If the value of the test goes below this threshold, drift is considered to have happened.
      monitoring_termination_threshold: Another, more strict, metric threshold. If the value of the test goes below this threshold, drift is considered not acceptable and ML model being used by the NWDAF(AnLF) must be terminated.

Subsequently, monitoring operations are performed according to the monitoring periods. For each monitoring object, the monitoring operation executes the test specified by the monitoring_metric, which is applied to the monitoring_attributes from the monitoring_datasource. The amount of data is ruled by start/end or size, as well as sampling_rate. The following operations can be performed by the NWDAF(DDLF) or by the NWDAF(MTLF), as discussed above.

For each monitoring point, drift is determined if the value of the test fulfils the condition stated by monitoring_metric_operator and monitoring_threshold. Once the drift is determined in each monitoring object, the logical expression described in monitoring_evaluation is applied. Depending on the presence and value of monitoring_drift_recurrent_events, the result obtained is stored. When the number of successive positive drift results reaches the value of the monitoring_drift_recurrent_events parameter, drift is considered to have occurred.

As another pre-requisite, as part of execution of an Analytics ID, the NWDAF (AnLF) has started to use a given ML model that is identified by its name and its version.

The NWDAF(AnLF) subscribes to notifications on the availability of new ML models using service operation Nnwdaf_MLModelProvision_Subscribe. Depending on their configuration, the NWDAF(AnLF) or the NF may store data associated to the monitoring objects into the ADRF (by means of the service operations included in the services in Nadrf). The storage may (but is not required to) involve MFAF and/or DCCF.

The NWDAF(MTLF) subscribes to notifications on drift monitoring provided by the NWDAF(DDLF). In some embodiments, this can be done via a new service, ML Drift Monitoring, with service operations Nnwdaf_MLModelDriftMonitoring_Subscribe and Nnwdaf_MLModelDriftMonitoring_Unsubscribe that can be used to initiate, modify, and cancel subscriptions from NWDAF(MTLF). The subscription request shown in FIG. 6 can include the following information:
Analytics ID(s) the drift monitoring operation refers to.
ML model identifier(s) the drift monitoring operation refers to, so that the NWDAF (MTLF) can map the Analytics ID(s) in the Nnwdaf_MLModelProvision_Subscribe service operation to their respective ML model identifiers.
Notification URL.
Timestamp value.
How long the notification is valid (optional; if absent, it is infinite).
   If accepted, the answer to the subscription request provides a subscription correlation identifier. Subscription cancellation or update requests must include the subscription correlation identifier that identifies the subscription to be modified or cancelled.

In addition to the information received in the subscription request, the NWDAF(DDLF) needs to know which drift monitoring operations it must carry out and how. To do so, the NWDAF(DDLF) needs to access the drift_detection_configuration section in the ML model meta-data described above. Considering that the ML model meta-data has been provisioned at the NWDAF (MTLF), there are two possible embodiments:
MWDAF(MTLF) includes that information in the Nnwdaf_MLModelDriftMonitoring_Subscribe request.
Upon reception of the Nnwdaf_MLModelDriftMonitoring_Subscribe request, NWDAF(DDLF) uses the Analytics ID(s) to retrieve ML model meta-data by a Nnwdaf_MLModelInfo Request service operation to the NWDAF(MTLF).

Drift monitoring operations at the NWDAF(DDLF) are triggered according to the values of the monitoring_period keys in the drift_detection_configuration section of the ML model meta-data. To get a result from a drift monitoring operation, the NWDAF(DDLF) reads data from the ADRF using the service operations included in any of the Nadrf services or has received real-time data from the NFs. As shown in FIG. 6, the data is written to the ADRF by one or more analytics data producer NFs, one or more analytics data consumer NFs, and/or the NWDAF (AnLF).

Each time a drift monitoring operation is executed, the NWDAF(DDLF) determines whether it must notify the NWDAF(MTLF). If so, it uses an Nnwdaf_MLModelDriftMonitoring_Notify service operation that is part of the ML Drift Monitoring service.

If the NWDAF(DDLF) is not responsible for determining whether drift has occurred, then it delivers a notification each time the drift monitoring operation is executed. In this case, a notification via Nnwdaf_MLModelDriftMonitoring_Notify service operation can include:
Analytics ID and/or identifier of the ML model associated with the Analytics ID, to which the drift monitoring operation refers;
Timestamp value; and
Result(s) of the data drift test or the accuracy metric for each monitoring object.

If the NWDAF(DDLF) is responsible for determining whether drift has occurred, then it delivers a notification only when drift (severe or not) has been detected. In this case, a notification via Nnwdaf_MLModelDriftMonitoring_Notify service operation can include:
Analytics ID and/or identifier of the ML model associated with the Analytics ID, to which the drift monitoring operation refers;
Timestamp value;
Optionally, a periodicity value indicating how frequently the drift monitoring operation is performed;
Optionally, result(s) of the data drift test or the accuracy metric for each monitoring object; and
Flag indicating whether the drift was determined to be severe (e.g., set to “true”).

In some embodiments, based on a received drift monitoring notification, the NWDAF(MTLF) determines whether:
to send a termination notification to the NWDAF(AnLF), based on applying the logical expression in monitoring_termination_evaluation; and/or
to train a new ML Model, based on applying the logical expression in monitoring_evaluation.

In other embodiments, no extra verification is needed, and retraining is programmed by the NWDAF(MTLF).

When the retraining operation is carried out, a new trained ML model binary is uploaded to a Model Repository and all subscribing NWDAF(AnLF) are notified. However, if the drift monitoring notification stated that drift was severe, all subscribing NWDAF(AnLF) are notified so that they can terminate the severely degraded ML model. In other words, depending on the type of notification, an NWDAF(AnLF) will terminate the ML model or retrieve the newly trained ML model, e.g., using procedures to swap model releases.

In general, drift monitoring operations are specific to each ML model. Different functionality is needed depending on the type of the ML model and the data used. In some embodiments, the NWDAF(DDLF) can create specific containers (e.g., Docker, OCI, etc.) or deployments (e.g., Kubernetes) that perform the drift monitoring operations but are discarded once those operation have been performed.

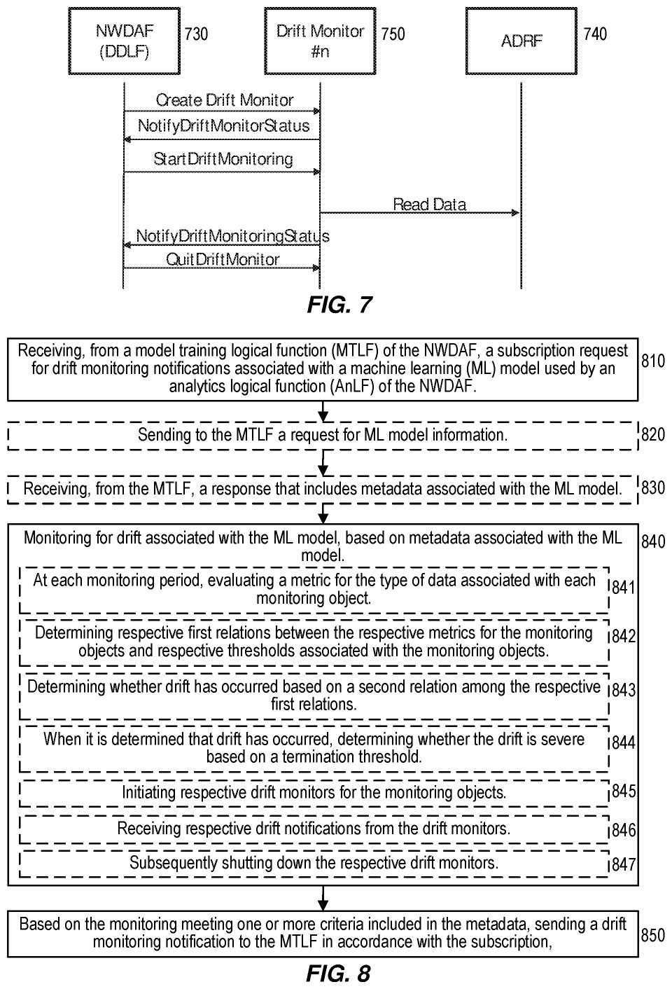

In these embodiments, the NWDAF (DDLF) can use operations to create/shut down specialized drift monitors, supply them with necessary information for operation, and send/receive information about the monitoring results. FIG. 7 shows an exemplary procedure for managing a drift monitor, according to these embodiments.

The NWDAF(DDLF) 730 can use cloud-native mechanisms (e.g., Helm charts for Kubernetes) to create a drift monitor instance, shown in FIG. 7 as Drift Monitor #n 750. Once Drift Monitor #n is up and running, it sends NotifyDriftMonitorStatus to notify NWDAF(DDLF) that it is alive and/or operational.

Upon receiving this notification from Drift Monitor #n, NWDAF(DDLF) sends StartDriftMonitoring to request Drift Monitor #n to perform a drift monitoring operation. The request contains relevant information such as size or time window of the training set to use to perform the ML model training operation, specific configuration to access an ADRF, monitoring objects, etc.

Upon receiving this request, Drift Monitor #n retrieves the dataset from the ADRF 740, performs drift tests for requested monitoring objects, and notifies NWDAF(DDLF) using NotifyDriftMonitoringStatus. The notification includes the results of the executed drift tests.

Upon receiving this notification, NWDAF(DDLF) may decide whether drift has occurred and, subsequently, sends QuitDriftMonitor to shut down Drift Monitor #n.

Although embodiments have been described above in the specific context of an NWDAF and its logical functions MTLF, AnLF, and DDLF, skilled persons will understand that underlying principles of the above-described embodiments are equally applicable to other NFs, logical functions, nodes, etc. (e.g., with different names) that perform similar operations as these respective entities.

These embodiments described above can be further illustrated with reference to FIGS. 8-10, which depict exemplary methods (e.g., procedures) for a DDLF, an MTLF, and an AnLF, respectively, of a NWDAF. Put differently, various features of the operations described below correspond to various embodiments described above. The exemplary methods shown in FIGS. 8-10 can be used cooperatively (e.g., with each other and with other procedures described herein) to provide benefits, advantages, and/or solutions to problems described herein. Although the exemplary methods are illustrated in FIGS. 8-10 by specific blocks in particular orders, the operations corresponding to the blocks can be performed in different orders than shown and can be combined and/or divided into blocks and/or operations having different functionality than shown. Optional blocks and/or operations are indicated by dashed lines.

More specifically, FIG. 8 illustrates an exemplary method (e.g., procedure) for a DDLF of an NWDAF of a communication network (e.g., 5GC), according to various embodiments of the present disclosure. The exemplary method shown in FIG. 8 can be performed by an NWDAF (DDLF) or a network node hosting an NWDAF (DDLF), such as described elsewhere herein.

The exemplary method can include the operations of block 810, where the DDLF can receive, from an MTLF of the NWDAF, a subscription request for drift monitoring notifications associated with an ML model used by an AnLF of the NWDAF. The exemplary method can also include the operations of block 840, where the DDLF can monitor for drift associated with the ML model, based on metadata associated with the ML model. The exemplary method can also include the operations of block 850, where based on the monitoring meeting one or more criteria included in the metadata, the DDLF can send one or more drift monitoring notification to the MTLF in accordance with the subscription.

In some embodiments, the monitoring is performed (e.g., in block 840) on a plurality of monitoring objects. Each monitoring object is associated with one of the following types of data:
raw data acquired by the AnLF for input to the ML model;
feature vectors computed by the AnLF based on the raw data; and
predictions based on the ML model.

In some variants, each monitoring object associated with predictions based on the ML model is also associated with actual values corresponding to the predictions, when such actual values are available.

In some of these embodiments, the metadata associated with the ML model includes a drift detection configuration, which includes one or more of the following for each particular one of the monitoring objects:
access information for data to be used for the particular monitoring object;
specific attributes and/or subsets of data to be used for the particular monitoring object; and
size, duration, and/or sampling ratio of data to be used for the particular monitoring object.

In some variants, the drift detection configuration also includes:
for each particular monitoring object associated with raw data or feature vectors, identification of supported data drift tests; and
for each particular monitoring object associated with predictions based on the ML model, identification of relevant performance metrics and one or more thresholds for each relevant performance metric.

In some embodiments, monitoring for drift in block 840 is performed periodically according to a monitoring period included in the metadata. Additionally, monitoring for drift can include the operations of sub-block 841, where the DDLF can, at each monitoring period, evaluate a metric for the type of data associated with each monitoring object.

In some of these embodiments, the one or more drift monitoring notifications sent to the MTLF include periodic drift monitoring notifications corresponding to the periodic evaluations.

In other words, the one or more criteria can be seen as periodic availability of the respective metrics. In such embodiments, each (periodic) drift monitoring notification includes one or more the following:
an identifier of the ML model or of analytics associated with the drift monitoring,
a timestamp,
observed drift levels associated with each monitoring object,
an identifier of a data drift test or performance metric used for each monitoring object, and
a value of the metric for the type of data associated with each monitoring object.

In other of these embodiments, monitoring for drift further comprises the following operations at each monitoring period, labelled with corresponding sub-block numbers:
(842) determining respective first relations between the respective metrics for the monitoring objects and respective thresholds associated with the monitoring objects; and
(843) determining whether drift has occurred based on a second relation among the respective first relations; and
(844) when it is determined that drift has occurred, determining whether the drift is severe based on a termination threshold.

The thresholds, the first relations, the second relation, and the termination threshold can be part of the drift monitoring configuration, such as in the example discussed above. As a more specific example, the per-object threshold can be defined by the “monitoring_threshold” metadata, the per-object first relation can be defined by the “monitoring_metric_operator” metadata, the second relation can be defined by the “monitoring_evaluation” metadata, and the termination threshold can be defined by the “monitoring_termination_evaluation” metadata.

In such embodiments, the one or more criteria in the metadata (i.e., that monitoring must meet to trigger a drift monitoring notification) include that drift has occurred. In such case, the drift monitoring notification includes one or more of the following:
an indication of whether the drift is severe;
an identifier of the ML model or of analytics associated with the drift monitoring;
a timestamp;
a periodicity of the drift monitoring; and
a value of the metric for the type of data associated with each monitoring object.

In some embodiments, monitoring for drift in block 840 can include the following operations, labelled with corresponding sub-block numbers:
(845) initiating respective drift monitors for the monitoring objects;
(846) receiving respective drift notifications from the drift monitors, and
(847) subsequently shutting down the respective drift monitors.

In such embodiments, the one or more drift monitoring notifications sent to the MTLF are based on the respective drift notifications from the drift monitors. An example of these embodiments is shown in FIG. 7, described above.

In some embodiments, the subscription request (e.g., received in block 810) includes one or more of the following:
the metadata associated with the ML model;
one or more analytics identifiers associated with the drift monitoring;
one or more ML model identifiers associated with the drift monitoring;
an address to send drift monitoring notifications;
a timestamp of the subscription request; and
a duration of validity for the subscription request.

In some of these embodiments (e.g., where the subscription request does not include the metadata), the exemplary method can also include the operations of blocks 820-830, where, in response to receiving the subscription request, the DDLF can send to the MTLF a request for ML model information and receive from the MTLF a response that includes the metadata associated with the ML model.

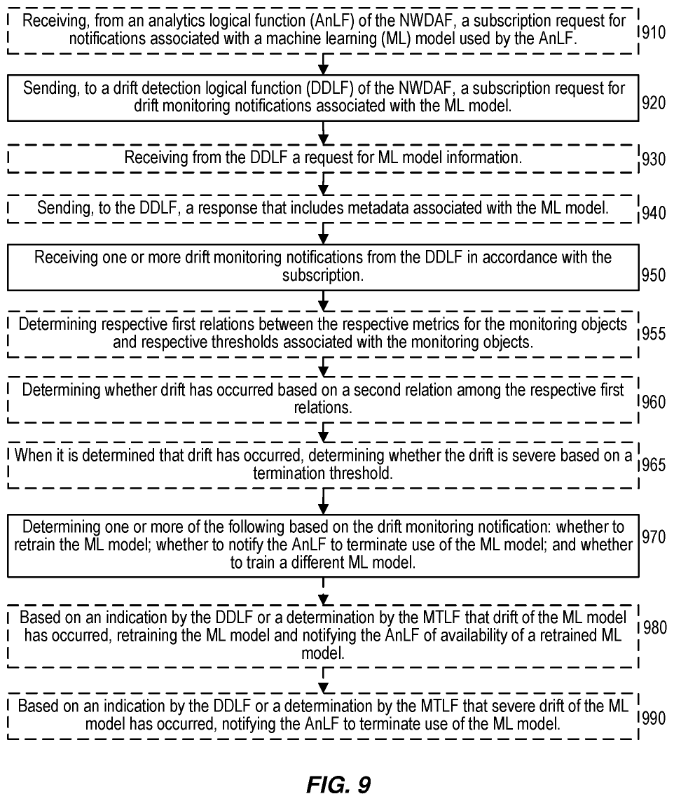

In addition, FIG. 9 illustrates an exemplary method (e.g., procedure) for a MTLF of a NWDAF of a communication network (e.g., 5GC), according to various embodiments of the present disclosure. The exemplary method shown in FIG. 9 can be performed by an NWDAF (MTLF) or a network node hosting an NWDAF (MTLF), such as described elsewhere herein.

The exemplary method can include the operations of block 920, where the MTLF can send, to a DDLF of the NWDAF, a subscription request for drift monitoring notifications associated with an ML model used by an AnLF of the NWDAF. The exemplary method can also include the operations of block 950, where the MTLF can subsequently receive one or more drift monitoring notifications from the DDLF in accordance with the subscription. The exemplary method can also include the operations of block 970, where the MTLF can determine one or more of the following based on the drift monitoring notifications: whether to retrain the ML model, whether to notify the AnLF to terminate use of the ML model, and whether to train a different ML model.

In some embodiments, the subscription request (e.g., sent in block 920) includes one or more of the following:
metadata associated with the ML model;
one or more analytics identifiers associated with the drift monitoring;
one or more ML model identifiers associated with the drift monitoring;
an address to send drift monitoring notifications;
a timestamp of the subscription request; and
a duration of validity for the subscription request.

In some embodiments (e.g., where the subscription request does not include the metadata), the exemplary method can also include the operations of blocks 930-940, where, in response to the subscription request (e.g., in block 920), the MTLF can receive from the DDLF a request for ML model information and send to the DDLF a response that includes the metadata associated with the ML model.

In some embodiments, each drift monitoring notification is based on a plurality of monitoring objects, with each monitoring object being associated with one of the following types of data:
raw data acquired by the AnLF for input to the ML model;
feature vectors computed by the AnLF based on the raw data; and
predictions based on the ML model.

In some variants, each monitoring object associated with predictions based on the ML model is also associated with actual values corresponding to the predictions, when such actual values are available.

In some of these embodiments, the metadata associated with the ML model includes a drift detection configuration, which includes one or more of the following for each particular one of the monitoring objects:
access information for data to be used for the particular monitoring object;
specific attributes and/or subsets of data to be used for the particular monitoring object; and
size, duration, and/or sampling ratio of data to be used for the particular monitoring object.

In some variants, the drift detection configuration also includes:
for each particular monitoring object associated with raw data or feature vectors, identification of supported data drift tests; and
for each particular monitoring object associated with predictions based on the ML model, identification of relevant performance metrics and one or more thresholds for each relevant performance metric.

In some embodiments, monitoring for drift is performed periodically by the DDLF according to a monitoring period included in the metadata. The one or more drift monitoring notifications received from the DDLF (e.g., in block 950) include periodic drift monitoring notifications corresponding to the monitoring period. In some of these embodiments, each (periodic) drift monitoring notification includes one or more the following:
an identifier of the ML model or of analytics associated with the drift monitoring,
a timestamp,
observed drift levels associated with each monitoring object,
an identifier of a data drift test or performance metric used for each monitoring object, and
a value of the metric for the type of data associated with each monitoring object.

In some of these embodiments, the exemplary method can also include the following operations at each monitoring period, labelled with corresponding block numbers:
(955) determining respective first relations between the respective metrics for the monitoring objects and respective thresholds associated with the monitoring objects;
(960) determining whether drift has occurred based on a second relation among the respective first relations; and
(965) when it is determined that drift has occurred, determining whether the drift is severe based on a termination threshold.

The thresholds, the first relations, the second relation, and the termination threshold can be part of the drift monitoring configuration, such as in the example discussed above. As a more specific example, the per-object threshold can be defined by the “monitoring_threshold” metadata, the per-object first relation can be defined by the “monitoring_metric_operator” metadata, the second relation can be defined by the “monitoring_evaluation” metadata, and the termination threshold can be defined by the “monitoring_termination_evaluation” metadata.

In other of these embodiments, each drift monitoring notification is received based on a determination by the DDLF that drift has occurred. In such embodiments, each drift monitoring notification includes one or more of the following:
an indication of whether the drift is severe;
an identifier of the ML model or of analytics associated with the drift monitoring;
a timestamp;
a periodicity of the drift monitoring; and
a value of a metric for the type of data associated with each monitoring object.

In some embodiments, the exemplary method can also include one or more of the following operations, labelled with corresponding block numbers:
(980) based on an indication by the DDLF or a determination by the MTLF that drift of the ML model has occurred, retraining the ML model and notifying the AnLF of availability of a retrained ML model; and
(990) based on an indication by the DDLF or a determination by the MTLF that severe drift of the ML model has occurred, notifying the AnLF to terminate use of the ML model.

In some of these embodiments, the exemplary method can also include the operations of block 910, where the MTLF can receive from the AnLF a subscription request for notifications associated with the ML model. The subscription request sent to the DDLF (e.g., in block 920) is based on the subscription request received from the AnLF. Also, notifying the AnLF (e.g., in block 980 and/or 990) is based on the subscription request.

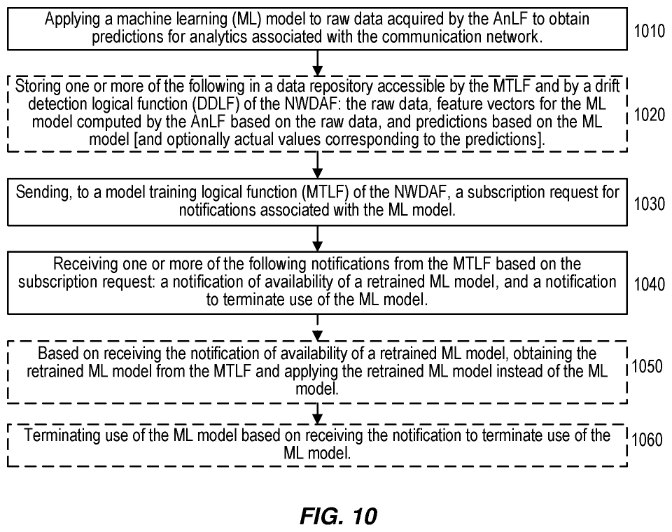

In addition, FIG. 10 illustrates an exemplary method (e.g., procedure) for an AnLF of a NWDAF of a communication network (e.g., 5GC), according to various embodiments of the present disclosure. The exemplary method shown in FIG. 10 can be performed by an NWDAF (AnLF) or a network node hosting an NWDAF (AnLF), such as described elsewhere herein.

The exemplary method can include the operations of block 1010, where the AnLF can apply an ML model to raw data acquired by the AnLF to obtain predictions for analytics associated with the communication network. The exemplary method can also include the operations of block 1030, where the AnLF can send, to an MTLF of the NWDAF, a subscription request for notifications associated with the ML model. The exemplary method can also include the operations of block 1040, where the AnLF can receive one or more of the following from the MTLF based on the subscription request: a notification of availability of a retrained ML model, and a notification to terminate use of the ML model.

In some embodiments, the subscription request to the MTLF includes one or more of the following:
metadata associated with the ML model;
one or more analytics identifiers;
one or more ML model identifiers;
an address to send notifications;
a timestamp of the subscription request; and
a duration of validity for the subscription request.

In some embodiments, the exemplary method can also include the operations of block 1020, where the AnLF can store one or more of the following information in a data repository accessible by the MTLF and by a drift detection logical function (DDLF) of the NWDAF:
the raw data;
feature vectors for the ML model computed by the AnLF based on the raw data; and
predictions based on the ML model.

In some variants, the information stored in the data repository also includes actual values corresponding to the predictions based on the ML model, when such actual values are available.

In some embodiments, the exemplary method can also include one or more of the following operations, labelled with corresponding block numbers:
based on receiving the notification of availability of a retrained ML model (e.g., in block 1040), obtaining the retrained ML model from the MTLF and applying the retrained ML model instead of the ML model; and
terminating use of the ML model based on receiving the notification to terminate use of the ML model (e.g., in block 1040).

Although various embodiments are described above in terms of methods, techniques, and/or procedures, the person of ordinary skill will readily comprehend that such methods, techniques, and/or procedures can be embodied by various combinations of hardware and software in various systems, communication devices, computing devices, control devices, apparatuses, non-transitory computer-readable media, computer program products, etc.

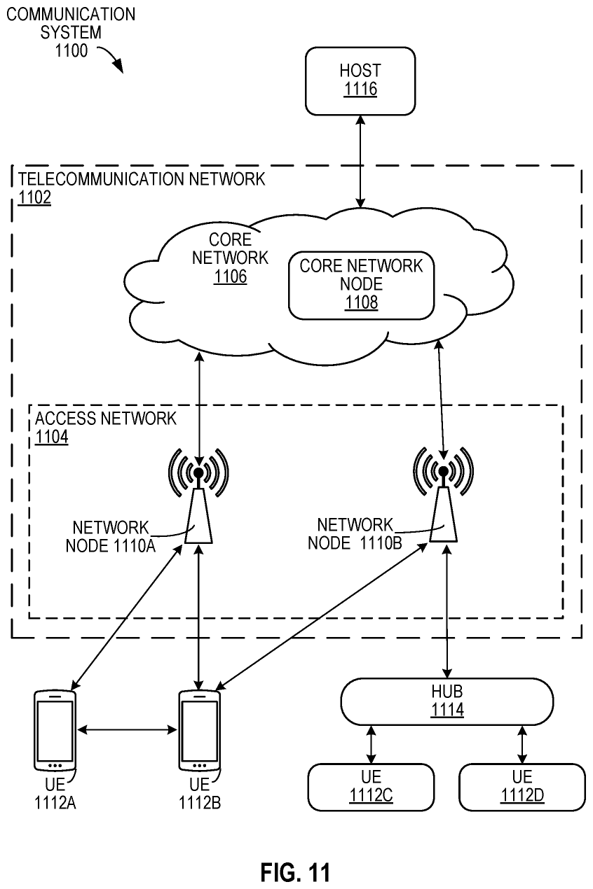

FIG. 11 shows an example of a communication system 1100 in accordance with some embodiments. In the example, the communication system 1100 includes a telecommunication network 1102 that includes an access network 1104 (e.g., a RAN) and a core network 1106, which includes one or more core network nodes 1108. The access network 1104 includes one or more access network nodes, such as network nodes 1110a and 1110b (one or more of which may be generally referred to as network nodes 1110), or any other similar 3GPP access node or non-3GPP access point. The network nodes 1110 facilitate direct or indirect connection of UEs, such as by connecting UEs 1112a, 1112b, 1112c, and 1112d (one or more of which may be generally referred to as UEs 1112) to the core network 1106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1100 may include any number of wired or wireless networks, network nodes, UEs, and/or any other components or systems that may facilitate or participate in the communication of data and/or signals whether via wired or wireless connections. The communication system 1100 may include and/or interface with any type of communication, telecommunication, data, cellular, radio network, and/or other similar type of system.

The UEs 1112 may be any of a wide variety of communication devices, including wireless devices arranged, configured, and/or operable to communicate wirelessly with the network nodes 1110 and other communication devices. Similarly, the network nodes 1110 are arranged, capable, configured, and/or operable to communicate directly or indirectly with the UEs 1112 and/or with other network nodes or equipment in the telecommunication network 1102 to enable and/or provide network access, such as wireless network access, and/or to perform other functions, such as administration in the telecommunication network 1102.

In the depicted example, the core network 1106 connects the network nodes 1110 to one or more hosts, such as host 1116. These connections may be direct or indirect via one or more intermediary networks or devices. In other examples, network nodes may be directly coupled to hosts. The core network 1106 includes one more core network nodes (e.g., core network node 1108) that are structured with hardware and software components. Features of these components may be substantially similar to those described with respect to the UEs, network nodes, and/or hosts, such that the descriptions thereof are generally applicable to the corresponding components of the core network node 1108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), Network Data Analytics Function (NWDAF), and/or a User Plane Function (UPF).

The host 1116 may be under the ownership or control of a service provider other than an operator or provider of the access network 1104 and/or the telecommunication network 1102 and may be operated by the service provider or on behalf of the service provider. The host 1116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1100 of FIG. 11 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1102 is a cellular network that implements 3GPP standardized features. Accordingly, the telecommunications network 1102 may support network slicing to provide different logical networks to different devices that are connected to the telecommunication network 1102. For example, the telecommunications network 1102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1112 are configured to transmit and/or receive information without direct human interaction. For instance, a UE may be designed to transmit information to the access network 1104 on a predetermined schedule, when triggered by an internal or external event, or in response to requests from the access network 1104. Additionally, a UE may be configured for operating in single- or multi-RAT or multi-standard mode. For example, a UE may operate with any one or combination of Wi-Fi, NR (New Radio) and LTE, i.e., being configured for multi-radio dual connectivity (MR-DC), such as E-UTRAN (Evolved-UMTS Terrestrial Radio Access Network) New Radio-Dual Connectivity (EN-DC).

In the example, the hub 1114 communicates with the access network 1104 to facilitate indirect communication between one or more UEs (e.g., UE 1112c and/or 1112d) and network nodes (e.g., network node 1110b). In some examples, the hub 1114 may be a controller, router, content source and analytics, or any of the other communication devices described herein regarding UEs. For example, the hub 1114 may be a broadband router enabling access to the core network 1106 for the UEs. As another example, the hub 1114 may be a controller that sends commands or instructions to one or more actuators in the UEs. Commands or instructions may be received from the UEs, network nodes 1110, or by executable code, script, process, or other instructions in the hub 1114. As another example, the hub 1114 may be a data collector that acts as temporary storage for UE data and, in some embodiments, may perform analysis or other processing of the data. As another example, the hub 1114 may be a content source. For example, for a UE that is a VR headset, display, loudspeaker or other media delivery device, the hub 1114 may retrieve VR assets, video, audio, or other media or data related to sensory information via a network node, which the hub 1114 then provides to the UE either directly, after performing local processing, and/or after adding additional local content. In still another example, the hub 1114 acts as a proxy server or orchestrator for the UEs, in particular in if one or more of the UEs are low energy IoT devices.

The hub 1114 may have a constant/persistent or intermittent connection to the network node 1110b. The hub 1114 may also allow for a different communication scheme and/or schedule between the hub 1114 and UEs (e.g., UE 1112c and/or 1112d), and between the hub 1114 and the core network 1106. In other examples, the hub 1114 is connected to the core network 1106 and/or one or more UEs via a wired connection. Moreover, the hub 1114 may be configured to connect to an M2M service provider over the access network 1104 and/or to another UE over a direct connection. In some scenarios, UEs may establish a wireless connection with the network nodes 1110 while still connected via the hub 1114 via a wired or wireless connection. In some embodiments, the hub 1114 may be a dedicated hub—that is, a hub whose primary function is to route communications to/from the UEs from/to the network node 1110b. In other embodiments, the hub 1114 may be a non-dedicated hub—that is, a device which is capable of operating to route communications between the UEs and network node 1110b, but which is additionally capable of operating as a communication start and/or end point for certain data channels.

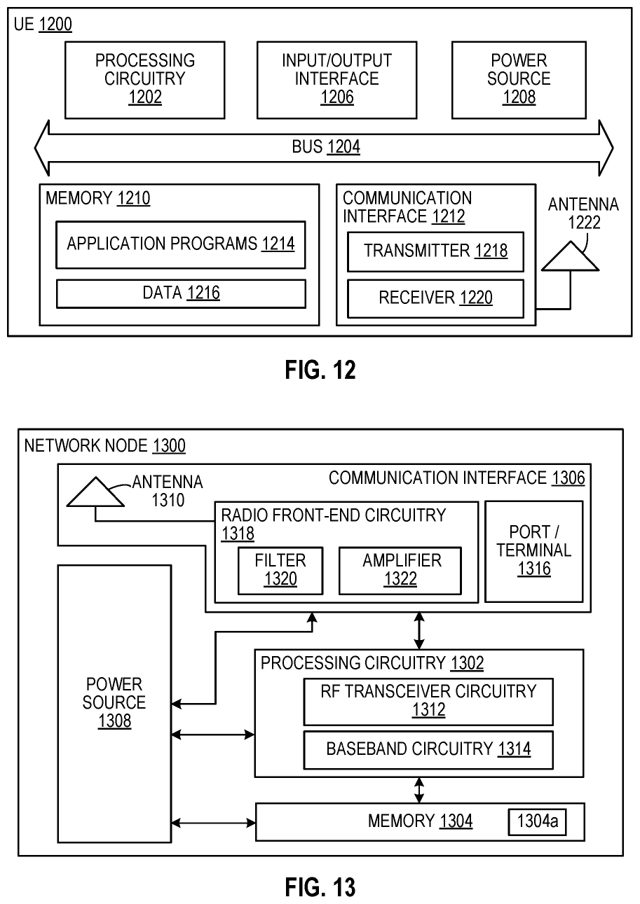

FIG. 12 shows a UE 1200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1200 includes processing circuitry 1202 that is operatively coupled via a bus 1204 to an input/output interface 1206, a power source 1208, a memory 1210, a communication interface 1212, and/or any other component, or any combination thereof. Certain UEs may utilize all or a subset of the components shown in FIG. 12. The level of integration between the components may vary from one UE to another UE. Further, certain UEs may contain multiple instances of a component, such as multiple processors, memories, transceivers, transmitters, receivers, etc.

The processing circuitry 1202 is configured to process instructions and data and may be configured to implement any sequential state machine operative to execute instructions stored as machine-readable computer programs in the memory 1210. The processing circuitry 1202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1202 may include multiple central processing units (CPUs).

In the example, the input/output interface 1206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1208 is structured as a battery or battery pack. Other types of power sources, such as an external power source (e.g., an electricity outlet), photovoltaic device, or power cell, may be used. The power source 1208 may further include power circuitry for delivering power from the power source 1208 itself, and/or an external power source, to the various parts of the UE 1200 via input circuitry or an interface such as an electrical power cable. Delivering power may be, for example, for charging of the power source 1208. Power circuitry may perform any formatting, converting, or other modification to the power from the power source 1208 to make the power suitable for the respective components of the UE 1200 to which power is supplied.

The memory 1210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1210 includes one or more application programs 1214, such as an operating system, web browser application, a widget, gadget engine, or other application, and corresponding data 1216. The memory 1210 may store, for use by the UE 1200, any of a variety of various operating systems or combinations of operating systems.

The memory 1210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1210 may allow the UE 1200 to access instructions, application programs and the like, stored on transitory or non-transitory memory media, to off-load data, or to upload data. An article of manufacture, such as one utilizing a communication system may be tangibly embodied as or in the memory 1210, which may be or comprise a device-readable storage medium.

The processing circuitry 1202 may be configured to communicate with an access network or other network using the communication interface 1212. The communication interface 1212 may comprise one or more communication subsystems and may include or be communicatively coupled to an antenna 1222. The communication interface 1212 may include one or more transceivers used to communicate, such as by communicating with one or more remote transceivers of another device capable of wireless communication (e.g., another UE or a network node in an access network). Each transceiver may include a transmitter 1218 and/or a receiver 1220 appropriate to provide network communications (e.g., optical, electrical, frequency allocations, and so forth). Moreover, the transmitter 1218 and receiver 1220 may be coupled to one or more antennas (e.g., antenna 1222) and may share circuit components, software or firmware, or alternatively be implemented separately.

In the illustrated embodiment, communication functions of the communication interface 1212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1200 shown in FIG. 12.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 13 shows a network node 1300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1300 includes a processing circuitry 1302, a memory 1304, a communication interface 1306, and a power source 1308. The network node 1300 may be composed of multiple physically separate components (e.g., a NodeB component and a RNC component, or a BTS component and a BSC component, etc.), which may each have their own respective components. In certain scenarios in which the network node 1300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1300 may be configured to support multiple radio access technologies (RATs). In such embodiments, some components may be duplicated (e.g., separate memory 1304 for different RATs) and some components may be reused (e.g., a same antenna 1310 may be shared by different RATs). The network node 1300 may also include multiple sets of the various illustrated components for different wireless technologies integrated into network node 1300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1300.

The processing circuitry 1302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1300 components, such as the memory 1304, to provide network node 1300 functionality.

In some embodiments, the processing circuitry 1302 includes a system on a chip (SOC). In some embodiments, the processing circuitry 1302 includes one or more of radio frequency (RF) transceiver circuitry 1312 and baseband processing circuitry 1314. In some embodiments, the radio frequency (RF) transceiver circuitry 1312 and the baseband processing circuitry 1314 may be on separate chips (or sets of chips), boards, or units, such as radio units and digital units. In alternative embodiments, part or all of RF transceiver circuitry 1312 and baseband processing circuitry 1314 may be on the same chip or set of chips, boards, or units.

The memory 1304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1302. The memory 1304 may store any suitable instructions, data, or information, including a computer program, software, an application including one or more of logic, rules, code, tables, and/or other instructions (collectively denoted computer program product 1304a) capable of being executed by the processing circuitry 1302 and utilized by the network node 1300. The memory 1304 may be used to store any calculations made by the processing circuitry 1302 and/or any data received via the communication interface 1306. In some embodiments, the processing circuitry 1302 and memory 1304 is integrated.

The communication interface 1306 is used in wired or wireless communication of signaling and/or data between a network node, access network, and/or UE. As illustrated, the communication interface 1306 comprises port(s)/terminal(s) 1316 to send and receive data, for example to and from a network over a wired connection. The communication interface 1306 also includes radio front-end circuitry 1318 that may be coupled to, or in certain embodiments a part of, the antenna 1310. Radio front-end circuitry 1318 comprises filters 1320 and amplifiers 1322. The radio front-end circuitry 1318 may be connected to an antenna 1310 and processing circuitry 1302. The radio front-end circuitry may be configured to condition signals communicated between antenna 1310 and processing circuitry 1302. The radio front-end circuitry 1318 may receive digital data that is to be sent out to other network nodes or UEs via a wireless connection. The radio front-end circuitry 1318 may convert the digital data into a radio signal having the appropriate channel and bandwidth parameters using a combination of filters 1320 and/or amplifiers 1322. The radio signal may then be transmitted via the antenna 1310. Similarly, when receiving data, the antenna 1310 may collect radio signals which are then converted into digital data by the radio front-end circuitry 1318. The digital data may be passed to the processing circuitry 1302. In other embodiments, the communication interface may comprise different components and/or different combinations of components.

In certain alternative embodiments, the network node 1300 does not include separate radio front-end circuitry 1318, instead, the processing circuitry 1302 includes radio front-end circuitry and is connected to the antenna 1310. Similarly, in some embodiments, all or some of the RF transceiver circuitry 1312 is part of the communication interface 1306. In still other embodiments, the communication interface 1306 includes one or more ports or terminals 1316, the radio front-end circuitry 1318, and the RF transceiver circuitry 1312, as part of a radio unit (not shown), and the communication interface 1306 communicates with the baseband processing circuitry 1314, which is part of a digital unit (not shown).

The antenna 1310 may include one or more antennas, or antenna arrays, configured to send and/or receive wireless signals. The antenna 1310 may be coupled to the radio front-end circuitry 1318 and may be any type of antenna capable of transmitting and receiving data and/or signals wirelessly. In certain embodiments, the antenna 1310 is separate from the network node 1300 and connectable to the network node 1300 through an interface or port.

The antenna 1310, communication interface 1306, and/or the processing circuitry 1302 may be configured to perform any receiving operations and/or certain obtaining operations described herein as being performed by the network node. Any information, data and/or signals may be received from a UE, another network node and/or any other network equipment. Similarly, the antenna 1310, the communication interface 1306, and/or the processing circuitry 1302 may be configured to perform any transmitting operations described herein as being performed by the network node. Any information, data and/or signals may be transmitted to a UE, another network node and/or any other network equipment.

The power source 1308 provides power to the various components of network node 1300 in a form suitable for the respective components (e.g., at a voltage and current level needed for each respective component). The power source 1308 may further comprise, or be coupled to, power management circuitry to supply the components of the network node 1300 with power for performing the functionality described herein. For example, the network node 1300 may be connectable to an external power source (e.g., the power grid, an electricity outlet) via an input circuitry or interface such as an electrical cable, whereby the external power source supplies power to power circuitry of the power source 1308. As a further example, the power source 1308 may comprise a source of power in the form of a battery or battery pack which is connected to, or integrated in, power circuitry. The battery may provide backup power should the external power source fail.

Embodiments of the network node 1300 may include additional components beyond those shown in FIG. 13 for providing certain aspects of the network node's functionality, including any of the functionality described herein and/or any functionality necessary to support the subject matter described herein. For example, the network node 1300 may include user interface equipment to allow input of information into the network node 1300 and to allow output of information from the network node 1300. This may allow a user to perform diagnostic, maintenance, repair, and other administrative functions for the network node 1300.

For example, one or more network nodes 1300 can be configured to perform operations attributed to an NWDAF (or logical functions thereof) in the descriptions herein of various methods or procedures. As a more specific example, the one or more network nodes 1300 can be configured to perform operations attributed to a DDLF of an NWDAF, an MTLF of an NWDAF, and an AnLF of the NWDAF.

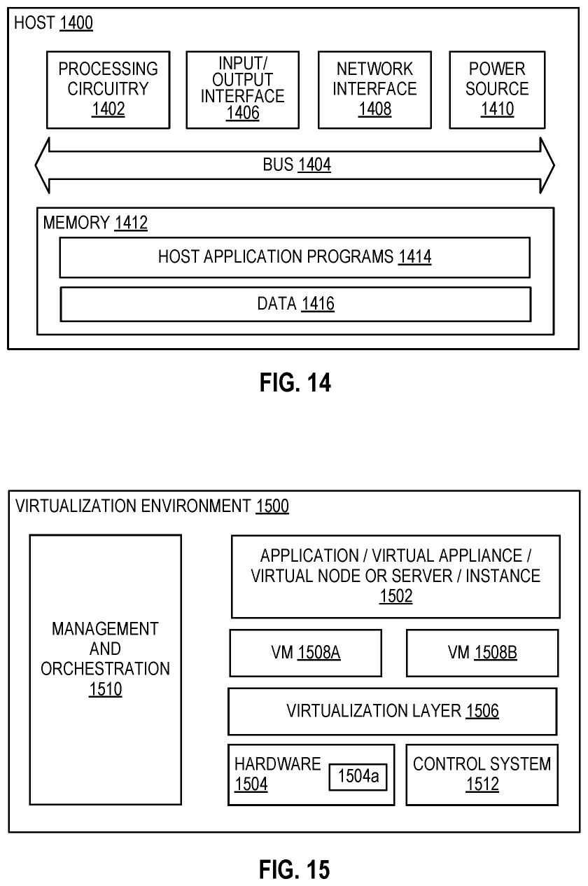

FIG. 14 is a block diagram of a host 1400, which may be an embodiment of the host 1116 of FIG. 11, in accordance with various aspects described herein. As used herein, the host 1400 may be or comprise various combinations hardware and/or software, including a standalone server, a blade server, a cloud-implemented server, a distributed server, a virtual machine, container, or processing resources in a server farm. The host 1400 may provide one or more services to one or more UEs.

The host 1400 includes processing circuitry 1402 that is operatively coupled via a bus 1404 to an input/output interface 1406, a network interface 1408, a power source 1410, and a memory 1412. Other components may be included in other embodiments. Features of these components may be substantially similar to those described with respect to the devices of previous figures, such as FIGS. 12 and 13, such that the descriptions thereof are generally applicable to the corresponding components of host 1400.

The memory 1412 may include one or more computer programs including one or more host application programs 1414 and data 1416, which may include user data, e.g., data generated by a UE for the host 1400 or data generated by the host 1400 for a UE. Embodiments of the host 1400 may utilize only a subset or all of the components shown. The host application programs 1414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1414 may also provide for user authentication and licensing checks and may periodically report health, routes, and content availability to a central node, such as a device in or on the edge of a core network. Accordingly, the host 1400 may select and/or indicate a different host for over-the-top services for a UE. The host application programs 1414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 15 is a block diagram illustrating a virtualization environment 1500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1502 (which may alternatively be called software instances, virtual appliances, network functions, virtual nodes, virtual network functions, etc.) are run in the virtualization environment 1500 to implement some of the features, functions, and/or benefits of some of the embodiments disclosed herein.

For example, an NWDAF (or logical functions thereof) described herein in relation to other figures, can be implemented as virtual network functions 1502 in virtualization environment 1500. As a more specific example, a DDLF of an NWDAF, an MTLF of an NWDAF, and/or an AnLF of the NWDAF can be implemented as virtual network functions 1502 in virtualization environment 1500.

Hardware 1504 includes processing circuitry, memory that stores software and/or instructions (collectively denoted computer program product 1504a) executable by hardware processing circuitry, and/or other hardware devices as described herein, such as a network interface, input/output interface, and so forth. Software may be executed by the processing circuitry to instantiate one or more virtualization layers 1506 (also referred to as hypervisors or virtual machine monitors (VMMs)), provide VMs 1508a and 1508b (one or more of which may be generally referred to as VMs 1508), and/or perform any of the functions, features and/or benefits described in relation with some embodiments described herein. The virtualization layer 1506 may present a virtual operating platform that appears like networking hardware to the VMs 1508.

The VMs 1508 comprise virtual processing, virtual memory, virtual networking or interface and virtual storage, and may be run by a corresponding virtualization layer 1506. Different embodiments of the instance of a virtual appliance 1502 may be implemented on one or more of VMs 1508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1508 may be a software implementation of a physical machine that runs programs as if they were executing on a physical, non-virtualized machine. Each of the VMs 1508, and that part of hardware 1504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1508 on top of the hardware 1504 and corresponds to the application 1502.

Hardware 1504 may be implemented in a standalone network node with generic or specific components. Hardware 1504 may implement some functions via virtualization. Alternatively, hardware 1504 may be part of a larger cluster of hardware (e.g., such as in a data center or CPE) where many hardware nodes work together and are managed via management and orchestration 1510, which, among others, oversees lifecycle management of applications 1502. In some embodiments, hardware 1504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1512 which may alternatively be used for communication between hardware nodes and radio units.

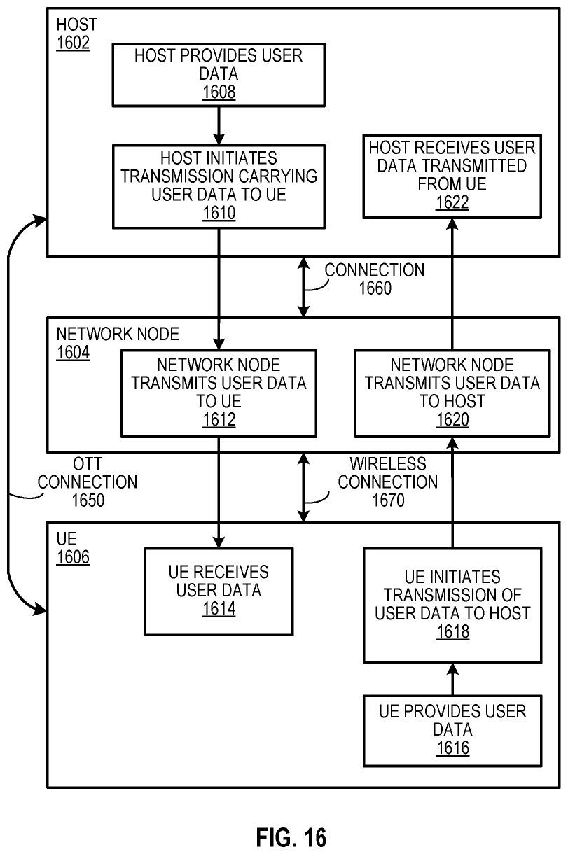

FIG. 16 shows a communication diagram of a host 1602 communicating via a network node 1604 with a UE 1606 over a partially wireless connection in accordance with some embodiments. Example implementations, in accordance with various embodiments, of the UE (such as a UE 1112a of FIG. 11 and/or UE 1200 of FIG. 12), network node (such as network node 1110a of FIG. 11 and/or network node 1300 of FIG. 13), and host (such as host 1116 of FIG. 11 and/or host 1400 of FIG. 14) discussed in the preceding paragraphs will now be described with reference to FIG. 16.

Like host 1400, embodiments of host 1602 include hardware, such as a communication interface, processing circuitry, and memory. The host 1602 also includes software, which is stored in or accessible by the host 1602 and executable by the processing circuitry. The software includes a host application that may be operable to provide a service to a remote user, such as the UE 1606 connecting via an over-the-top (OTT) connection 1650 extending between the UE 1606 and host 1602. In providing the service to the remote user, a host application may provide user data which is transmitted using the OTT connection 1650.

The network node 1604 includes hardware enabling it to communicate with the host 1602 and UE 1606. The connection 1660 may be direct or pass through a core network (like core network 1106 of FIG. 11) and/or one or more other intermediate networks, such as one or more public, private, or hosted networks. For example, an intermediate network may be a backbone network or the Internet.

The UE 1606 includes hardware and software, which is stored in or accessible by UE 1606 and executable by the UE's processing circuitry. The software includes a client application, such as a web browser or operator-specific “app” that may be operable to provide a service to a human or non-human user via UE 1606 with the support of the host 1602. In the host 1602, an executing host application may communicate with the executing client application via the OTT connection 1650 terminating at the UE 1606 and host 1602. In providing the service to the user, the UE's client application may receive request data from the host's host application and provide user data in response to the request data. The OTT connection 1650 may transfer both the request data and the user data. The UE's client application may interact with the user to generate the user data that it provides to the host application through the OTT connection 1650.

The OTT connection 1650 may extend via a connection 1660 between the host 1602 and the network node 1604 and via a wireless connection 1670 between the network node 1604 and the UE 1606 to provide the connection between the host 1602 and the UE 1606. The connection 1660 and wireless connection 1670, over which the OTT connection 1650 may be provided, have been drawn abstractly to illustrate the communication between the host 1602 and the UE 1606 via the network node 1604, without explicit reference to any intermediary devices and the precise routing of messages via these devices.

As an example of transmitting data via the OTT connection 1650, in step 1608, the host 1602 provides user data, which may be performed by executing a host application. In some embodiments, the user data is associated with a particular human user interacting with the UE 1606. In other embodiments, the user data is associated with a UE 1606 that shares data with the host 1602 without explicit human interaction. In step 1610, the host 1602 initiates a transmission carrying the user data towards the UE 1606. The host 1602 may initiate the transmission responsive to a request transmitted by the UE 1606. The request may be caused by human interaction with the UE 1606 or by operation of the client application executing on the UE 1606. The transmission may pass via the network node 1604, in accordance with the teachings of the embodiments described throughout this disclosure. Accordingly, in step 1612, the network node 1604 transmits to the UE 1606 the user data that was carried in the transmission that the host 1602 initiated, in accordance with the teachings of the embodiments described throughout this disclosure. In step 1614, the UE 1606 receives the user data carried in the transmission, which may be performed by a client application executed on the UE 1606 associated with the host application executed by the host 1602.

In some examples, the UE 1606 executes a client application which provides user data to the host 1602. The user data may be provided in reaction or response to the data received from the host 1602. Accordingly, in step 1616, the UE 1606 may provide user data, which may be performed by executing the client application. In providing the user data, the client application may further consider user input received from the user via an input/output interface of the UE 1606. Regardless of the specific manner in which the user data was provided, the UE 1606 initiates, in step 1618, transmission of the user data towards the host 1602 via the network node 1604. In step 1620, in accordance with the teachings of the embodiments described throughout this disclosure, the network node 1604 receives user data from the UE 1606 and initiates transmission of the received user data towards the host 1602. In step 1622, the host 1602 receives the user data carried in the transmission initiated by the UE 1606.

One or more of the various embodiments improve the performance of OTT services provided to the UE 1606 using the OTT connection 1650, in which the wireless connection 1670 forms the last segment. More precisely, embodiments can facilitate detecting drift in an ML model used for NWDAF analytics and providing timely indication of the drift to a MTLF, which can retrain the ML model before the inaccuracy due to drift reaches an unacceptable level, e.g., in advance of a periodic and/or predefined model retraining event. Alternately, the MTLF can trigger termination of the ML model when the detected drift and/or inaccuracy becomes too severe, reports. Additionally, detection and provisioning of ML model drift is simplified since it is performed by a specific logical function, e.g., DDLF. In this manner, embodiments can facilitate improved analysis within the network (particularly based on ML models), which can improve network performance. Such improved network performance can increase the value of OTT services delivered via the network to both service providers and end users.

In an example scenario, factory status information may be collected and analyzed by the host 1602. As another example, the host 1602 may process audio and video data which may have been retrieved from a UE for use in creating maps. As another example, the host 1602 may collect and analyze real-time data to assist in controlling vehicle congestion (e.g., controlling traffic lights). As another example, the host 1602 may store surveillance video uploaded by a UE. As another example, the host 1602 may store or control access to media content such as video, audio, VR or AR which it can broadcast, multicast or unicast to UEs. As other examples, the host 1602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1650 between the host 1602 and UE 1606, in response to variations in the measurement results. The measurement procedure and/or the network functionality for reconfiguring the OTT connection may be implemented in software and hardware of the host 1602 and/or UE 1606. In some embodiments, sensors (not shown) may be deployed in or in association with other devices through which the OTT connection 1650 passes; the sensors may participate in the measurement procedure by supplying values of the monitored quantities exemplified above or supplying values of other physical quantities from which software may compute or estimate the monitored quantities. The reconfiguring of the OTT connection 1650 may include message format, retransmission settings, preferred routing etc.; the reconfiguring need not directly alter the operation of the network node 1604. Such procedures and functionalities may be known and practiced in the art. In certain embodiments, measurements may involve proprietary UE signaling that facilitates measurements of throughput, propagation times, latency, etc. by host 1602. The measurements may be implemented in that software causes messages to be transmitted, in particular empty or ‘dummy’ messages, using the OTT connection 1650 while monitoring propagation times, errors, etc.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures that, although not explicitly shown or described herein, embody the principles of the disclosure and can be thus within the spirit and scope of the disclosure. Various embodiments can be used together with one another, as well as interchangeably therewith, as should be understood by those having ordinary skill in the art.

The term unit, as used herein, can have conventional meaning in the field of electronics, electrical devices and/or electronic devices and can include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

As described herein, device and/or apparatus can be represented by a semiconductor chip, a chipset, or a (hardware) module comprising such chip or chipset; this, however, does not exclude the possibility that a functionality of a device or apparatus, instead of being hardware implemented, be implemented as a software module such as a computer program or a computer program product comprising executable software code portions for execution or being run on a processor. Furthermore, functionality of a device or apparatus can be implemented by any combination of hardware and software. A device or apparatus can also be regarded as an assembly of multiple devices and/or apparatuses, whether functionally in cooperation with or independently of each other. Moreover, devices and apparatuses can be implemented in a distributed fashion throughout a system, so long as the functionality of the device or apparatus is preserved. Such and similar principles are considered as known to a skilled person.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

In addition, certain terms used in the present disclosure, including the specification and drawings, can be used synonymously in certain instances (e.g., “data” and “information”). It should be understood, that although these terms (and/or other terms that can be synonymous to one another) can be used synonymously herein, there can be instances when such words can be intended to not be used synonymously.

Example embodiments of the techniques and apparatus described herein include, but are not limited to, the following enumerated embodiments:

A1. A method for a drift detection logical function (DDLF) of a network data analytics function (NWDAF) of a communication network, the method comprising:
receiving, from a model training logical function (MTLF) of the NWDAF, a subscription request for drift monitoring notifications associated with a machine learning (ML) model used by an analytics logical function (AnLF) of the NWDAF;
monitoring for drift associated with the ML model, based on metadata associated with the ML model; and
based on the monitoring meeting one or more criteria included in the metadata, sending one or more drift monitoring notification to the MTLF in accordance with the subscription.

A2. The method of embodiment A1, wherein the monitoring is performed on a plurality of monitoring objects, wherein each monitoring object is associated with one of the following types of data:
raw data acquired by the AnLF for input to the ML model;
feature vectors computed by the AnLF based on the raw data; and
predictions based on the ML model and actual values corresponding to the predictions.

A3. The method of embodiment A2, wherein:
the metadata associated with the ML model includes a drift detection configuration; and
the drift detection configuration includes one or more of the following for each particular one of the monitoring objects:
   access information for data to be used for the particular monitoring object;
   specific attributes and/or subsets of data to be used for the particular monitoring object; and
   size, duration, and/or sampling ratio of data to be used for the particular monitoring object.

A4. The method of embodiment A3, wherein the drift detection configuration also includes:
for each particular monitoring object associated with raw data or feature vectors, identification of supported data drift tests; and
for each particular monitoring object associated with predictions and actual values, identification of relevant performance metrics and threshold for each relevant performance metric.

A5. The method of any of embodiment A2-A4, wherein:
monitoring for drift is performed periodically according to a monitoring period included in the metadata; and
monitoring for drift comprises, at each monitoring period, evaluating a metric for the type of data associated with each monitoring object.

A6. The method of embodiment A5, wherein:
periodic drift monitoring notifications corresponding to the periodic evaluations are sent to the MTLF; and
each drift monitoring notification includes one or more the following:
   an identifier of the ML model or of analytics associated with the drift monitoring,
   a timestamp,
   observed drift levels associated with each monitoring object,
   an identifier of a data drift test or accuracy metric used for each monitoring object, and
   a value of the metric for the type of data associated with each monitoring object.

A7. The method of embodiment A5, wherein monitoring for drift further comprises, at each monitoring period:
determining respective first relations between the respective metrics for the monitoring objects and respective thresholds associated with the monitoring objects; and
determining whether drift has occurred based on a second relation among the respective first relations; and
when it is determined that drift has occurred, determining whether the drift is severe based on a termination threshold.

A8. The method of embodiment A7, wherein:
the one or more criteria include a determination that drift has occurred; and
the drift monitoring notification includes one or more of the following:
   an indication of whether the determined drift is severe;
   an identifier of the ML model or of analytics associated with the drift monitoring;
   a timestamp;
   a periodicity of the drift monitoring; and
   a value of the metric for the type of data associated with each monitoring object.

A9. The method of any of embodiments A2-A8, wherein monitoring for drift comprises:
initiating respective drift monitors for the monitoring objects;
receiving respective drift notifications from the drift monitors, wherein the one or more drift monitoring notifications are based on the respective drift notifications; and
subsequently shutting down the respective drift monitors.

A10. The method of any of embodiments A1-A9, wherein the subscription request includes one or more of the following:
the metadata associated with the ML model;
one or more analytics identifiers associated with the drift monitoring;
one or more ML model identifiers associated with the drift monitoring;
an address to send drift monitoring notifications;
a timestamp of the subscription request; and
a duration of validity for the subscription request.

A11. The method of embodiment A10, further comprising:
in response to the subscription request, sending to the MTLF a request for ML model information; and
receiving, from the MTLF, a response that includes the metadata associated with the ML model.

B1. A method for a model training logical function (MTLF) of a network data analytics function (NWDAF) of a communication network, the method comprising:
sending, to a drift detection logical function (DDLF) of the NWDAF, a subscription request for drift monitoring notifications associated with a machine learning (ML) model used by an analytics logical function (AnLF) of the NWDAF;
subsequently receiving one or more drift monitoring notifications from the DDLF in accordance with the subscription; and
determining one or more of the following based on the drift monitoring notifications:
   whether to retrain the ML model;
   whether to notify the AnLF to terminate use of the ML model; and
   whether to train a different ML model.

B2. The method of embodiment B1, wherein the subscription request includes one or more of the following:
metadata associated with the ML model;
one or more analytics identifiers associated with the drift monitoring;
one or more ML model identifiers associated with the drift monitoring;
an address to send drift monitoring notifications;
a timestamp of the subscription request; and
a duration of validity for the subscription request.

B3. The method of embodiment B2, further comprising:
in response to the subscription request, receiving from the DDLF a request for ML model information; and
sending, to the DDLF, a response that includes the metadata associated with the ML model.

B4. The method of any of embodiments B2-B3, wherein the drift monitoring notification is based on a plurality of monitoring objects, wherein each monitoring object is associated with one of the following types of data:
raw data acquired by the AnLF for input to the ML model;
feature vectors computed by the AnLF based on the raw data; and
predictions based on the ML model and actual values corresponding to the predictions.

B5. The method of embodiment B4, wherein:
the metadata associated with the ML model includes a drift detection configuration; and
the drift detection configuration includes one or more of the following for each particular one of the monitoring objects:
   access information for data to be used for the particular monitoring object;
   specific attributes and/or subsets of data to be used for the particular monitoring object; and
   size, duration, and/or sampling ratio of data to be used for the particular monitoring object.
   B6. The method of embodiment B5, wherein the drift detection configuration also includes:
for each particular monitoring object associated with raw data or feature vectors, identification of supported data drift tests; and
for each particular monitoring object associated with predictions and actual values, identification of relevant performance metrics and threshold for each relevant performance metric.

B7. The method of any of embodiments B4-B6, wherein:
monitoring for drift is performed periodically by the DDLF according to a monitoring period included in the metadata; and
periodic drift monitoring notifications corresponding to the periodic evaluations are received from the MTLF.

B8. The method of embodiment B7, wherein each drift monitoring notification includes one or more the following:
an identifier of the ML model or of analytics associated with the drift monitoring, a timestamp,
observed drift levels associated with each monitoring object,
an identifier of a data drift test or accuracy metric used for each monitoring object, and
a value of a metric for the type of data associated with each monitoring object.

B9. The method of embodiment B8, further comprising, at each monitoring period:
determining respective first relations between the respective metrics for the monitoring objects and respective thresholds associated with the monitoring objects;
determining whether drift has occurred based on a second relation among the respective first relations; and
when it is determined that drift has occurred, determining whether the drift is severe based on a termination threshold.

B10. The method of any of embodiments B4-B6, wherein:
each drift monitoring notification is received based on a determination by the DDLF that drift has occurred; and
each drift monitoring notification includes one or more of the following:
   an indication of whether the determined drift is severe;
   an identifier of the ML model or of analytics associated with the drift monitoring;
   a timestamp;
   a periodicity of the drift monitoring; and
   a value of a metric for the type of data associated with each monitoring object.

B11. The method of any of embodiments B1-B10, further comprising, based on an indication by the DDLF or a determination by the MTLF that the drift of the ML model has occurred, retraining the ML model and notifying the AnLF of availability of a retrained ML model.

B12. The method of any of embodiments B1-B11, further comprising notifying the AnLF to terminate use of the ML model based on an indication by the DDLF or a determination by the MTLF that the drift of the ML model is severe.

B13. The method of any of embodiments B11-B12, further comprising receiving, from the AnLF, a subscription request for notifications associated with the ML model, wherein:
the subscription request to the DDLF for drift monitoring notifications is based on the subscription request received from the AnLF; and
notifying the AnLF is based on the subscription request.

C1. A method for an analytics logical function (AnLF) of a network data analytics function (NWDAF) of a communication network, the method comprising:
applying a machine learning (ML) model to raw data acquired by the AnLF to obtain predictions for analytics associated with the communication network;
sending, to a model training logical function (MTLF) of the NWDAF, a subscription request for notifications associated with the ML model; and
receiving one or more of the following from the MTLF based on the subscription request:
   a notification of availability of a retrained ML model; and
   a notification to terminate use of the ML model.

C2. The method of embodiment B1, wherein the subscription request to the MTLF includes one or more of the following:
metadata associated with the ML model;
one or more analytics identifiers;
one or more ML model identifiers;
an address to send notifications;
a timestamp of the subscription request; and
a duration of validity for the subscription request.

C3. The method of any of embodiments C1-C2, further comprising storing one or more of the following in a data repository accessible by the MTLF and by a drift detection logical function (DDLF) of the NWDAF:
the raw data;
feature vectors for the ML model computed by the AnLF based on the raw data; and
predictions based on the ML model and actual values corresponding to the predictions.

C4. The method of any of embodiments C1-C3, further comprising, based on receiving a notification of availability of a retrained ML model, obtaining the retrained ML model from the MTLF and applying the retrained ML model instead of the ML model.

C5. The method of any of embodiments C1-C3, further comprising terminating use of the ML model based on receiving a notification to terminate use of the ML model.

D1. A drift detection logical function (DDLF) of a network data analytics function (NWDAF) of a communication network, wherein:
the DDLF is implemented by communication interface circuitry and processing circuitry that are operably coupled; and
the processing circuitry and interface circuitry are configured to perform operations corresponding to any of the methods of embodiments A1-A11.

D2. A drift detection logical function (DDLF) of a network data analytics function (NWDAF) of a communication network, the DDLF being configured to perform operations corresponding to any of the methods of embodiments A1-A11.

D3. A non-transitory, computer-readable medium storing computer-executable instructions that, when executed by processing circuitry associated with a drift detection logical function (DDLF) of a network data analytics function (NWDAF) of a communication network, configure the DDLF to perform operations corresponding to any of the methods of embodiments A1-A11.

D4. A computer program product comprising computer-executable instructions that, when executed by processing circuitry associated with a drift detection logical function (DDLF) of a network data analytics function (NWDAF) of a communication network, configure the DDLF to perform operations corresponding to any of the methods of embodiments A1-A11.

E1. A model training logical function (MTLF) of a network data analytics function (NWDAF) of a communication network, wherein:
the MTLF is implemented by communication interface circuitry and processing circuitry that are operably coupled; and
the processing circuitry and interface circuitry are configured to perform operations corresponding to any of the methods of embodiments B1-B13.

E2. A model training logical function (MTLF) of a network data analytics function (NWDAF) of a communication network, the MTLF being configured to perform operations corresponding to any of the methods of embodiments B1-B13.

E3. A non-transitory, computer-readable medium storing computer-executable instructions that, when executed by processing circuitry associated with a model training logical function (MTLF) of a network data analytics function (NWDAF) of a communication network, configure the MTLF to perform operations corresponding to any of the methods of embodiments B1-B13.

E4. A computer program product comprising computer-executable instructions that, when executed by processing circuitry associated with a model training logical function (MTLF) of a network data analytics function (NWDAF) of a communication network, configure the MTLF to perform operations corresponding to any of the methods of embodiments B1-B13.

F1. An analytics logical function (AnLF) of a network data analytics function (NWDAF) of a communication network, wherein:
the AnLF is implemented by communication interface circuitry and processing circuitry that are operably coupled; and
the processing circuitry and interface circuitry are configured to perform operations corresponding to any of the methods of embodiments C1-C5.

F2. An analytics logical function (AnLF) of a network data analytics function (NWDAF) of a communication network, the AnLF being configured to perform operations corresponding to any of the methods of embodiments C1-C5.

F3. A non-transitory, computer-readable medium storing computer-executable instructions that, when executed by processing circuitry associated with an analytics logical function (AnLF) of a network data analytics function (NWDAF) of a communication network, configure the AnLF to perform operations corresponding to any of the methods of embodiments C1-C5.

F4. A computer program product comprising computer-executable instructions that, when executed by processing circuitry associated with an analytics logical function (AnLF) of a network data analytics function (NWDAF) of a communication network, configure the AnLF to perform operations corresponding to any of the methods of embodiments C1-C5.

1.-48. (canceled)

49. A method performed by a network data analytics function (NWDAF) of a communication network for monitoring drift associated with a machine learning (ML) model, the method comprising:
receiving, from a model training logical function (MTLF) of the NWDAF or of a second NWDAF, a subscription request for drift monitoring notifications associated with a machine learning (ML) model used by an analytics logical function (AnLF) of the NWDAF;
monitoring for drift associated with the ML model, based on metadata associated with the ML model; and
based on the monitoring meeting one or more criteria included in the metadata, sending one or more drift monitoring notifications to the MTLF in accordance with the subscription.

50. The method of claim 49, wherein:
the monitoring is performed on one or more monitoring objects; and
each monitoring object is associated with at least one of the following types of data:
raw data acquired by the AnLF for input to the ML model;
feature vectors computed by the AnLF based on the raw data;
predictions based on the ML model; and
actual values corresponding to the predictions based on the ML model, when such actual values are available.

51. The method of claim 50, wherein:
the metadata associated with the ML model includes a drift detection configuration; and
the drift detection configuration includes one or more of the following for each particular one of the monitoring objects:
access information for data to be used for the particular monitoring object;
specific attributes and/or subsets of data to be used for the particular monitoring object; and
size, duration, and/or sampling ratio of data to be used for the particular monitoring object.

52. The method of claim 51, wherein the drift detection configuration also includes:
for each particular monitoring object associated with raw data or feature vectors, identification of supported data drift tests; and
for each particular monitoring object associated with predictions based on the ML model, identification of relevant performance metrics and one or more thresholds for each relevant performance metric.

53. The method of claim 49, wherein:
the metadata includes one or more of the following: a monitoring or notification period, and one or more performance thresholds; and
each of the one or more drift monitoring notifications is sent to the MTLF based on the monitoring meeting one or more of the following criteria related to the metadata:
periodic availability of one or more monitored performance metrics according to the monitoring or notification period, or
a relation between one or more monitored performance metrics and corresponding ones of the performance thresholds, indicating that drift has occurred.

54. The method of claim 53, wherein:
monitoring for drift is performed on one or more monitoring objects; and
each drift monitoring notification includes one or more the following:
an identifier of the ML model or of analytics associated with the drift monitoring,
a timestamp,
observed drift levels associated with each monitoring object,
an identifier of a data drift test or performance metric used for each monitoring object, and
a value of a monitored performance metric for the type of data associated with each monitoring object.

55. The method of claim 53, wherein monitoring for drift is performed on one or more monitoring objects and comprises, at each monitoring or notification period:
evaluating respective performance metrics for the monitoring objects;
determining respective first relations between the respective performance metrics for the monitoring objects and respective performance thresholds associated with the monitoring objects; and
determining whether drift has occurred based on a second relation among the respective first relations; and
when it is determined that drift has occurred, determining whether the drift is severe based on a termination threshold.

56. The method of claim 55, wherein:
the one or more criteria in the metadata include that drift has occurred; and
the drift monitoring notification includes one or more of the following:
an indication of whether the drift is severe;
an identifier of the ML model or of analytics associated with the drift monitoring;
a timestamp;
a periodicity of the drift monitoring; and
a value of the metric for the type of data associated with each monitoring object.

57. The method of claim 49, wherein the subscription request includes one or more of the following:
the metadata associated with the ML model;
one or more analytics identifiers associated with the drift monitoring;
one or more ML model identifiers associated with the drift monitoring;
an address to send drift monitoring notifications;
a timestamp of the subscription request; and
a duration of validity for the subscription request.

58. A method performed by a model training logical function (MTLF) of a network data analytics function (NWDAF) of a communication network, the method comprising:
sending, to an analytics logical function (AnLF) of the NWDAF or of a second NWDAF, a subscription request for drift monitoring notifications associated with a machine learning (ML) model used by the AnLF of the NWDAF or of the second NWDAF;
receiving one or more drift monitoring notifications from the AnLF in accordance with the subscription; and
determining one or more of the following based on the drift monitoring notifications:
whether to retrain the ML model;
whether to notify the AnLF to terminate use of the ML model; and
whether to train a different ML model.

59. The method of claim 58, wherein the subscription request includes one or more of the following:
metadata associated with the ML model;
one or more analytics identifiers associated with the drift monitoring;
one or more ML model identifiers associated with the drift monitoring;
an address to send drift monitoring notifications;
a timestamp of the subscription request; and
a duration of validity for the subscription request.

60. (canceled)

61. The method of claim 59, wherein:
each drift monitoring notification is based on one or more monitoring objects; and
each monitoring object is associated with at least one of the following types of data:
raw data acquired by the AnLF for input to the ML model;
feature vectors computed by the AnLF based on the raw data;
predictions based on the ML model; and
actual values corresponding to the predictions based on the ML model, when such actual values are available.

62. The method of claim 61, wherein:
the metadata associated with the ML model includes a drift detection configuration; and
the drift detection configuration includes one or more of the following for each particular one of the monitoring objects:
access information for data to be used for the particular monitoring object;
specific attributes and/or subsets of data to be used for the particular monitoring object; and
size, duration, and/or sampling ratio of data to be used for the particular monitoring object.

63. The method of claim 62, wherein the drift detection configuration also includes:
for each particular monitoring object associated with raw data or feature vectors, identification of supported data drift tests; and
for each particular monitoring object associated with predictions based on the ML model, identification of relevant performance metrics and one or more thresholds for each relevant performance metric.

64. The method of claim 59, wherein:
the metadata includes one or more of the following: a monitoring or notification period, and one or more performance thresholds; and
each of the one or more drift monitoring notifications is received from the AnLF based on one or more of the following criteria related to the metadata: periodic availability of a performance metric according to the monitoring or notification period, or a relation between a performance metric and one of the performance thresholds.

65. The method of claim 64, wherein each drift monitoring notification includes one or more the following:
an identifier of the ML model or of analytics associated with the drift monitoring,
a timestamp,
observed drift levels associated with each of one or more monitoring objects,
an identifier of a data drift test or performance metric used for each monitoring object, and
a value of a performance metric for the type of data associated with each monitoring object.

66. The method of claim 65, further comprising, at each monitoring or notification period:
determining respective first relations between the respective performance metrics for the monitoring objects and respective performance thresholds associated with the monitoring objects;
determining whether drift has occurred based on a second relation among the respective first relations; and
when it is determined that drift has occurred, determining whether the drift is severe based on a termination threshold.

67. The method of claim 61, wherein:
each drift monitoring notification is received based on a determination by the AnLF that drift has occurred; and
each drift monitoring notification includes one or more of the following:
an indication of whether the drift is severe;
an identifier of the ML model or of analytics associated with the drift monitoring;
a timestamp;
a periodicity of the drift monitoring; and
a value of a metric for the type of data associated with each monitoring object.

68. The method of claim 58, further comprising or more of the following:
based on the one or more drift monitoring notifications indicating that drift of the ML model has occurred, retraining the ML model and notifying the AnLF of availability of a retrained ML model; and
based on the one or more drift monitoring notifications indicating that severe drift of the ML model has occurred, notifying the AnLF to terminate use of the ML model.

69. A method performed by an analytics logical function (AnLF) of a network data analytics function (NWDAF) of a communication network, the method comprising:
applying a machine learning (ML) model to raw data acquired by the AnLF to obtain predictions for analytics associated with the communication network;
sending, to a model training logical function (MTLF) of the NWDAF, a subscription request for notifications associated with the ML model; and
receiving a notification to terminate use of the ML model from the MTLF based on the subscription request.

70. The method of claim 69, wherein the subscription request to the MTLF includes one or more of the following:
metadata associated with the ML model;
one or more analytics identifiers;
one or more ML model identifiers;
an address to send notifications;
a timestamp of the subscription request; and
a duration of validity for the subscription request.

71. The method of claim 69, further comprising storing one or more of the following information in a data repository accessible by the MTLF:
the raw data;
feature vectors for the ML model computed by the AnLF based on the raw data;
predictions based on the ML model; and
actual values corresponding to the predictions based on the ML model, when such actual values are available.

72. Network equipment configured to implement a drift detection logical function (DDLF) of a network data analytics function (NWDAF) of a communication network, wherein:
the network equipment comprises communication interface circuitry and processing circuitry that are operably coupled; and
the processing circuitry and the communication interface circuitry are configured to perform the method of claim 49.

73. Network equipment configured to implement a model training logical function (MTLF) of a network data analytics function (NWDAF) of a communication network, wherein:
the network equipment comprises communication interface circuitry and processing circuitry that are operably coupled; and
the processing circuitry and interface circuitry are configured to perform the method of claim 58.

74. Network equipment configured to implement an analytics logical function (AnLF) of a network data analytics function (NWDAF) of a communication network, wherein:
the network equipment comprises communication interface circuitry and processing circuitry that are operably coupled; and
the processing circuitry and communication interface circuitry are configured to perform the method of claim 69.
